(19) United States
(12) Patent Application Publication
(10) Pub. No.: US 2021/0158197 A1
(43) Pub. Date: May 27, 2021

(54) BIOLOGY EXPERIMENT DESIGNS

(71) Applicant: The Regents of the University of California, Oakland, CA (US)

(72) Inventors: Zachary Costello, Berkeley, CA (US); Tijana Radivojevic, Berkeley, CA (US); Hector Garcia Martin, Oakland, CA (US)

(21) Appl. No.: 17/104,817

(22) Filed: Nov. 25, 2020

Related U.S. Application Data
(60) Provisional application No. 62/940,761, filed on Nov. 26, 2019.
(60) Provisional application No. 63/033,138, filed on Jun. 1, 2020.

(51) Int. Cl. G06N 7/00; G06N 20/20

(52) U.S. Cl. CPC G06N 7/005; G06N 20/20

(57) ABSTRACT

Disclosed herein include systems, devices, and methods for training and using a probabilistic predictive ensemble model for recommending experiment designs for a biology (e.g., synthetic biology) experiment. Also disclosed herein include methods for performing a biology (e.g., synthetic biology) experiment using a probabilistic predictive ensemble model for recommending experiment designs for biology.

### CROSS-REFERENCE TO RELATED APPLICATIONS

This application claims the benefit of priority to U.S. Provisional Patent Application No. 62/940,761, filed Nov. 26, 2019, and U.S. Provisional Patent Application No. 63/033,138, filed Jun. 1, 2020; the content of each of which is incorporated herein by reference in its entirety.

### STATEMENT REGARDING FEDERALLY SPONSORED R&D

This invention was made with government support under grant no. DE-AC02-05CH11231 awarded by U.S. Department of Energy, Office of Science, Office of Biological and Environmental Research. The government has certain rights in the invention.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

### Field

This disclosure relates generally to the field of synthetic biology, and more particularly to guiding synthetic biology.

### Background

Synthetic biology allows bioengineering of cells to synthesize novel valuable molecules such as renewable biofuels or anticancer drugs. However, traditional synthetic biology approaches involve ad-hoc engineering practices, which lead to long development times. There is a need to practice synthetic biology systematically.

### SUMMARY

Disclosed herein include systems for training a probabilistic predictive model for recommending experiment designs for biology, such as synthetic biology. In some embodiments, a system for training a probabilistic predictive model for recommending experiment designs for synthetic biology comprises: non-transitory memory configured to store executable instructions; and a hardware processor in communication with the non-transitory memory, the hardware processor programmed by the executable instructions to: receive synthetic biology experimental data. The hardware processor can be programmed by the executable instructions to: generate training data from the synthetic biology experimental data. The training data can comprise a plurality of training inputs and corresponding reference outputs. Each of the plurality of training inputs can comprise training values of input variables. Each of the plurality of reference outputs can comprise a reference value of at least one response variable associated with a predetermined response variable objective. The hardware processor can be programmed by the executable instructions to: train, using the training data, a plurality of level-0 learners of a probabilistic predictive model for recommending experiment designs for synthetic biology. An input of each of the plurality of level-0 learners can comprise input values of the input variables. An output of each of the plurality of level-0 learners can comprise a predicted value of at least one response variable. The hardware processor can be programmed by the executable instructions to: train, using (i) predicted values of the at least one response variable determined using the plurality of level-0 learners for the training inputs of the plurality of training inputs, and (ii) the reference outputs of the plurality of reference outputs correspondence to the training inputs of the plurality of training inputs, a level-1 learner of the probabilistic predictive model for recommending experiment designs for synthetic biology comprising a probabilistic ensemble of the plurality of level-0 learners. An output of the level-1 learner can comprise a predicted probabilistic distribution of the at least one response variable.

In some embodiments, the synthetic biology experimental data comprise experimental data obtained from one or more cycles of a synthetic biology experiment. The synthetic biology experimental data can comprise experimental data obtained from 5 cycles of the synthetic biology experiment. The synthetic biology experimental data can comprise experimental data obtained from one, or each, prior cycle of a synthetic biology experiment. The synthetic biology experimental data can comprise experimental data not obtained from any cycle of a synthetic biology experiment.

In some embodiments, the synthetic biology experimental data comprise genomics data, transcriptomics data, epigenomics, proteomics data, metabolomics data, microbiomics data, or a combination thereof. The synthetic biology experimental data can comprise multiomics data. In some embodiments, the synthetic biology experimental data comprise metabolic engineering experimental data and/or genetic engineering experimental data. The predetermined response variable objective can comprise a metabolic engineering objective and/or a genetic engineering objective. The synthetic biology experimental data can comprise experimental data of one or more pathways. One, or each, of the one or more pathways can comprise 5 or more proteins and/or 5 or more genes. The one or more pathways can comprise one or more metabolic pathways and/or one or more signaling pathways.

In some embodiments, the synthetic biology experimental data is obtained from one or more cells, or organisms, of a species. At least one of the one or more pathways can be endogenous to the one or more cells, or organisms. At least one of the one or more pathways can be related to a pathway of the one or more cells, or organisms. At least one of the one or more pathways can have high coupling to one, or each, pathway of the one or more cells, or organisms. At least one of the one or more pathways can have high coupling to metabolism of the one or more cells, or organisms. At least one of the one or more pathways can have low coupling to one, or each, pathway of the one or more cells, or organisms. At least one the one or more pathways can have low coupling to metabolism of the one or more cells, or organisms. At least one of the one or more pathways can be exogenous to the one or more cells, or organisms. The species can be a prokaryote, a bacterium, E. Coli, an archaeon, an eukaryote, a yeast, a virus, or a combination thereof.

In some embodiments, the synthetic biology experimental data is sparse. A number of the plurality of training inputs can be a number of experimental conditions, a number of strains, a number of replicates of a strain of the strains, or a combination thereof. A number of the plurality of training inputs can be about 5, 10, 16, 50, 100, or 1000. The training data can comprise a plurality of training vector representing the plurality of training inputs. A number of the input variables can about 2, 10, 50, 100, 500, or 1000.

In some embodiments, one, or each, of the plurality of input variables comprises a promoter sequence, an induction time, an induction strength, a ribosome binding sequence, a copy number of a gene, a transcription level of a gene, an epigenetics state of a gene, a splicing state of a gene, a level of a protein, a post translation modification state of a protein, a level of a molecule, an identity of a molecule, a level of a microbe, a state of a microbe, a state of a microbiome, a titer, a rate, a yield, or a combination thereof. The molecule can be an inorganic molecule, an organic molecule, a protein, a polypeptide, a carbohydrate, a sugar, a fatty acid, a lipid, an alcohol, a fuel, a metabolite, a drug, an anticancer drug, a biofuel molecule, a flavoring molecule, a fertilizer molecule, or a combination thereof.

In some embodiments, the at least one response variable comprises a copy number of a gene, a transcription level of a gene, an epigenetics state of a gene, a level of a protein, a post translation modification state of a protein, a level of a molecule, an identity of a molecule, a level of a microbe, a state of a microbe, a state of a microbiome, a titer, a rate, a yield, or a combination thereof. The molecule can be an inorganic molecule, an organic molecule, a protein, a polypeptide, a carbohydrate, a sugar, a fatty acid, a lipid, an alcohol, a fuel, a metabolite, a drug, an anticancer drug, a biofuel molecule, a flavoring molecule, a fertilizer molecule, or a combination thereof.

In some embodiments, the at least one response variable comprises two or more response variables each associated with a predetermined response variable objective. The predetermined response variable objectives of all of the two of more response variables can be identical. The predetermined response variable objectives of two response variables of the two of more response variables can be identical. The predetermined response variable objectives of two response variables of the two of more response variables can different. The predetermined response variable objectives of all of the two of more response variables can be identical. The predetermined response variable objective can comprise a maximization objective, a minimization objective, or a specification objective. The predetermined response variable objective can comprise maximizing the at least one response variable, minimizing the at least one response variable, or adjusting the at least one response variable to a predetermined value of the at least one response variable.

In some embodiments, to train the plurality of level-1 learner, the hardware processor is programmed by the executable instructions to: determine, using the plurality of level-0 learners, the predicted values of the at least one response variable for training inputs of the plurality of training inputs. The level-1 learner can comprise a Bayesian ensemble of the plurality of level-0 learners.

In some embodiments, parameters of the ensemble of the plurality of level-0 learners comprises (i) a plurality of ensemble weights and (ii) an error variable distribution of the ensemble or a standard deviation of the error variable distribution of the ensemble. The error variable distribution of the ensemble of the plurality of level-0 learners can comprise a normally distributed error variable. The error variable distribution of the ensemble can have a mean of zero. All ensemble weights of the plurality of ensemble weights can be normalized to 1. One, or each, ensemble weight of the plurality of ensemble weights can be non-negative. An ensemble weight of the plurality of ensemble weights can indicate a relative confidence of the level-0 learner of the plurality of level-0 learners weighted by the weight.

In some embodiments, the level-1 learner comprises a weighted combination of the plurality of level-0 learners with level-0 learners of the plurality of level-0 learners weighed by weights of the plurality of ensemble weights. The level-1 learner can comprise a weighted linear combination of the plurality of level-0 learners with level-0 learners of the plurality of level-0 learners weighed by weights of the plurality of ensemble weights.

In some embodiments, to train the level-1 learner, the hardware processor is programmed by the executable instructions to: determine a posterior distribution of the ensemble parameters given the training data or the second subset of the training data. To determine the posterior distribution of the ensemble parameters given the training data or the second subset of the training data, the hardware processor can be programmed by the executable instructions to: determine (i) a probability distribution of the training data or the second subset of the training data given the ensemble parameters or a likelihood function of the ensemble parameters given the training data of the second subset of the training data, and (ii) a prior distribution of the ensemble parameters. To determine the posterior distribution of the ensemble parameters given the training data or the second subset of the training data, the hardware processor can be programmed by the executable instructions to: sample a space of the ensemble parameters with a frequency proportional to a desired posterior distribution.

In some embodiments, to train the plurality of level-0 learners, the hardware processor is programmed by the executable instructions to: generate a first subset of the training data; and train, using the first subset of the training data, the plurality of level-0 learners. To train the plurality of level-1 learner, the hardware processor can be programmed by the executable instructions to: generate a second subset of the training data; and train, using (i) the predicted values of the at least one response variable determined using the plurality of level-0 learners for the training inputs of the second subset of the training data, and (ii) the corresponding reference outputs of the second subset of the training data corresponding to the training inputs of the second subset of the training data, the plurality of level-1 learners. The first subset of the training data and the second subset of the training data can be non-overlapping. To generate the second subset of the training data, the hardware processor can be programmed by the executable instructions to: generate the second subset of the training data randomly, semi-randomly, or non-randomly. The hardware processor can be programmed by the executable instructions to: train or retrain, using all training inputs and corresponding reference outputs of the training data, the plurality of level-0 learners of the probabilistic predictive model for recommending experiment designs for synthetic biology.

In some embodiments, two level-0 learners of the plurality of level-0 learners comprise machine learning models of an identical type with different parameters. No two level-0 learners of the plurality of level-0 learners can comprise machine learning models of an identical type. The plurality of level-0 learners can comprise a probabilistic machine learning model. The plurality of level-0 learners can comprise no probabilistic machine learning model. The plurality of level-0 learners can comprise a non-probabilistic machine learning model. The plurality of level-0 learners can comprise a deep learning model. The plurality of level-0 learners can comprise no deep learning model. The plurality of level-0 learners can comprise a non-deep learning model. The plurality of level-0 learners can comprise a random forest, a neural network, a support vector regressor, a kernel ridge regressor, a K-NN regressor, a Gaussian process regressor, a gradient boosting regressor, a tree-based pipeline optimization tool (TPOT), or a combination thereof. The plurality of level-0 learners can comprise about 10 machine learning models.

In some embodiments, the hardware processor is programmed by the executable instructions to: determine a surrogate function with an input experiment design as an input, the surrogate function comprising an expected value of the at least one response variable determined using the input experiment design, a variance of the value of the at least one response variable determined using the input experiment design, and an exploitation-exploration trade-off parameter; and determine, using the surrogate function, a plurality of recommended experiment designs, each comprising recommended values of the input variables, for a next cycle of a synthetic biology experiment for obtaining a predetermined response variable objective associated with the at least one response variable. The next cycle of the synthetic biology experiment can comprise a 6th cycle of the synthetic biology experiment.

In some embodiments, the exploitation-exploration trade-off parameter is 0 to 1. The exploitation-exploration trade-off parameter can be close to about 1 if a current cycle and/or the next cycle of the synthetic biology experiment is an early cycle of the synthetic biology experiment. The exploitation-exploration trade-off parameter can be close to about 0 if the current cycle and/or the next cycle of the synthetic biology experiment is a later cycle of the synthetic biology experiment. In some embodiments, the surrogate function comprises no expected value of the at least one response variable determined using the possible recommended experiment design when the exploitation-exploration trade-off parameter is 1. The surrogate function can comprise no variance of the value of the at least one response variable determined using the possible recommended experiment design when the exploitation-exploration trade-off parameter is 0.

In some embodiments, the hardware processor is programmed by the executable instructions to: determine the exploitation-exploration trade-off parameter based on a current and/or the next cycle of the synthetic biology experiment. The exploitation-exploration trade-off parameter can be predetermined.

In some embodiments, to determine the plurality of recommended experiment designs, the hardware processor is programmed by the executable instructions to: maximize the surrogate function. In some embodiments, to determine the plurality of recommended experiment designs, the hardware processor is programmed by the executable instructions to: determine a plurality of possible recommended experiment designs each comprising possible recommended values of the input variables with surrogate function values, determined using the surrogate function, with a predetermined characteristics; and select the plurality of recommended experiment designs from the plurality of possible recommended experiment designs using an input variable difference factor based on the surrogate function values of the plurality of possible recommended experiment designs. The recommended value of at least one input variable of each of the plurality of recommended experiment designs can differ from the recommended value of the at least one input variable of every other recommended experiment design of the plurality of recommended experiment designs and the training data by the input variable difference factor. The input variable difference factor can be 0.2.

In some embodiments, to select the plurality of recommended experiment designs from the plurality of possible recommended experiment designs using the input variable difference factor, the hardware processor is programmed by the executable instructions to: iteratively, for possible recommended experiment designs of the plurality of possible recommended experiment designs in an order of the predetermined characteristics, determine a possible recommended value of at least one input variable of a possible recommended experiment design of the plurality of possible recommended experiment designs differs from the recommended value of the at least one input variable of one or more recommended experiment designs of the plurality of recommended experiment designs already selected, if any, and the training data by the input variable difference factor; and select the possible recommended experiment design of the plurality of possible recommended experiment designs as a recommended experiment design of the plurality of recommended experiment designs. The hardware processor can be programmed by the executable instructions to: determine a number of the possible recommended experiment designs selected is below a desired number of the plurality recommended experiment designs; and decrease the input variable difference factor.

In some embodiments, the desired number of the plurality of recommended experiment designs is predetermined. The hardware processor can be programmed by the executable instructions to: determine the desired number of the plurality of recommended experiment designs based on a probability of one, or each, of the possible recommended experiment designs selected achieving the predetermined response variable objective associated with the at least one response variable and/or a probability of at least one of the plurality of possible recommended experiment designs selected achieving the predetermined response variable objective associated with the at least one response variable.

In some embodiments, a number of the plurality of recommended experiment designs corresponds to a number of experimental conditions or a number of strains for the next cycle of the synthetic biology experiment. The plurality of recommended experiment designs can comprise one or more gene drives and/or one or more pathway designs. A number of the plurality of recommended experiment designs can be about 2, 5, 10, 16, 50, 100, or 1000. The desired number of the plurality recommended experiment designs can be about 2, 5, 10, 16, 50, 100, or 1000.

In some embodiments, to determine the plurality of possible recommended experiment designs, the hardware processor is programmed by the executable instructions to: sample a space of the input variables with a frequency proportional to the surrogate function, or an exponential function of the surrogate function, and a prior distribution of the input variables. To sample the space of the input variables, the hardware processor can be programmed by the executable instructions to: sample the space of the input variables at a plurality of temperatures.

In some embodiments, the hardware processor is programmed by the executable instructions to: determine an upper bound and/or a lower bound for one, or each, of the plurality of input variables based on training values of the corresponding input variable. Each of the possible recommended values of the input variables can be within the upper bound and/or the lower bound of the corresponding input variable. The upper bound of one, or each, of the plurality of input variables can be a predetermined upper bound factor higher than a highest training value of the training values of the corresponding input variable. The predetermined upper bound factor can be about 0.05. The lower bound of one, or each, of the plurality of input variables can be a predetermined lower bound factor lower than a lowest training value of the training values of the corresponding input variable. The predetermined lower bound factor can be about 0.05. In some embodiments, the hardware processor is programmed by the executable instructions to: receive an upper bound and/or a lower bound for one, or each, of the plurality of input variables. Each of the possible recommended values of the input variables can be within the upper bound and/or the lower bound of the corresponding input variable.

In some embodiments, the hardware processor is programmed by the executable instructions to: determine, using the posterior distribution of the ensemble parameters given the training data or the second subset of the training data, a probability distribution of the at least one response variable for one, or each, of the plurality of recommended experiment designs.

In some embodiments, the hardware processor is programmed by the executable instructions to: determine, using the posterior distribution of the ensemble parameters given the training data or the second subset of the training data, a probability of one, or each, of the plurality of recommended experiment designs achieving the predetermined response variable objective associated with the at least one response variable. The probability of one, or each, of the plurality of recommended experiment designs achieving the predetermined response variable objective associated with the at least one response variable can comprise the probability of one, or each, of the plurality of recommended experiment designs being a predetermined percentage closer to achieving the objective relative to the training data. In some embodiments, the hardware processor is programmed by the executable instructions to: determine, using the posterior distribution of the ensemble parameters given the training data or the second subset of the training data, a probability of at least one of the plurality of recommended experiment designs achieving the predetermined response variable objective associated with the at least one response variable. The probability of the at least one of the plurality of recommended experiment designs achieving the predetermined response variable objective associated with the at least one response variable can comprise the probability of the at least one of the plurality of recommended experiment designs achieving the predetermined response variable objective being a predetermined percentage closer to achieving the objective relative to the training data. The predetermined percentage can be 10%.

Disclosed herein include methods for recommending experiment designs for biology, such as synthetic biology. In some embodiments, a method for recommending experiment designs for biology is under control of a hardware processor and comprises: receiving a probabilistic predictive model for recommending experiment designs for synthetic biology comprising a plurality of level-0 learners and a level-1 learner. An input of each of the plurality of level-0 learners can comprise input values of the input variables. An output of each of the plurality of level-0 learners can comprise a predicted value of at least one response variable. The level-1 learner can comprise a probabilistic ensemble of the plurality of level-0 learners. An output of the level-1 learner can comprise a predicted probabilistic distribution of the at least one response variable. The plurality of level-0 learners and the level-1 learner can be trained using training data obtained from one or more cycles of a synthetic biology experiment comprising a plurality of training inputs and corresponding reference outputs. Each of the plurality of training inputs can comprise training values of input variables. Each of the plurality of reference outputs can comprise a reference value of at least one response variable associated with a predetermined response variable objective. The method can comprise: determining a surrogate function comprising an expected value of the level-1 learner, a variance of the level-1 learner, and an exploitation-exploration trade-off parameter. The method can comprise: determining, using the surrogate function, a plurality of recommended experiment designs, each comprising recommended values of the input variables, for a next cycle of the synthetic biology experiment for achieving a predetermined response variable objective associated with the at least one response variable.

In some embodiments, the method comprises: training the plurality of level-0 learners and the level-1 learner using the synthetic biology experimental data. Training the plurality of level-0 learners and the level-1 learner using the synthetic biology experimental data can comprise: training the plurality of level-0 learners and the level-1 learner using the synthetic biology experimental data using any system of the present disclosure. Training the plurality of level-0 learners and the level-1 learner can comprise: generating the training data from synthetic biology experimental data obtained from one or more cycles of a synthetic biology experiment; training, using the training data, the plurality of level-0 learners of the probabilistic predictive model for recommending experiment designs for synthetic biology; and training, using (i) predicted values of the at least one response variable determined using the plurality of level-0 learners for the training inputs of the plurality of training inputs, and (ii) the reference outputs of the plurality of reference outputs correspondence to the training inputs of the plurality of training inputs, a level-1 learner of the probabilistic predictive model for recommending experiment designs for synthetic biology. The method can comprise: determining, using the probabilistic predictive model, a predicted probability distribution of the response variable for each of the plurality of recommended experiment designs.

Disclosed herein include methods for performing a biology (e.g., synthetic biology) experiment. In some embodiments, a method for performing a synthetic biology experiment comprises: performing one cycle of a synthetic biology experiment to obtain synthetic biology experimental data; training a probabilistic predictive model for recommending experiment designs for synthetic biology using the synthetic biology experimental data as described herein; determining a plurality of recommended experiment designs using the probabilistic predictive model; and performing a next cycle of the synthetic biology experiment using the plurality of recommended experiment designs.

In some embodiments, a method for performing a synthetic biology experiment comprises, for each cycle of a plurality of cycles of a synthetic biology experiment: performing the cycle of the synthetic biology experiment to obtain synthetic biology experimental data for the cycle; training a probabilistic predictive model for recommending experiment designs for synthetic biology using the synthetic biology experimental data of the cycle and any prior cycle, if any, as described herein; determining a plurality of recommended experiment designs using the probabilistic predictive model; and performing a next cycle of the synthetic biology experiment using the plurality of recommended experiment designs. The plurality of cycles of the synthetic biology experiment can comprise about 10 cycles of the synthetic biology experiment.

Details of one or more implementations of the subject matter described in this specification are set forth in the accompanying drawings and the description below. Other features, aspects, and advantages will become apparent from the description, the drawings, and the claims. Neither this summary nor the following detailed description purports to define or limit the scope of the inventive subject matter.

### BRIEF DESCRIPTION OF THE DRAWINGS

FIG. 1. Automated Recommendation Tool (ART) predicts the response from the input and provides recommendations for the next cycle.

FIG. 2. ART provides a probabilistic predictive model of the response (e.g., production).

FIG. 3. ART chooses recommendations for next steps by sampling the modes of a surrogate function.

FIG. 4 is a flow diagram showing an exemplary method of training and using a probabilistic predictive ensemble model for recommending experiment designs for biology.

FIG. 5 is a block diagram of an illustrative computing system configured to implement training and/or using a probabilistic predictive ensemble model for recommending experiment designs for biology.

FIG. 6. The main ART source code structure and dependencies.

FIG. 7. Functions presenting different levels of difficulty to being learnt, used to produce synthetic data and test ART's performance (FIG. 8).

FIG. 8. ART performance improves significantly by proceeding beyond the usual two Design-Build-Test-Learn cycles.

FIG. 9. Mean Absolute Error (MAE) for the synthetic data set in FIG. 8.

FIG. 10. ART provided effective recommendations to improve renewable biofuel (limonene) production.

FIG. 11. All machine learning algorithms pointed in the same direction to improve limonene production, in spite of quantitative differences in prediction.

FIG. 12. ART produced effective recommendations to bioengineer yeast to produce hoppy beer without hops.

FIG. 13. Linalool and geraniol predictions for ART recommendations for each of the beers (FIG. 12), showing full probability distributions (not just averages).

FIG. 14. Principal Component Analysis (PCA) of proteomics data for the hopless beer project (FIG. 12), showing experimental results for cycle 1 and 2, as well as ART recommendations for both cycles.

FIG. 15. ART's predictive power was heavily compromised in the dodecanol production demonstration case.

FIG. 16. ART's predictive power for the second pathway in the dodecanol production demonstration case was very limited.

FIG. 17 ART's predictive power for the third pathway in the dodecanol production demonstration case was poor.

Throughout the drawings, reference numbers may be re-used to indicate correspondence between referenced elements. The drawings are provided to illustrate example embodiments described herein and are not intended to limit the scope of the disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein and made part of the disclosure herein.

All patents, published patent applications, other publications, and sequences from GenBank, and other databases referred to herein are incorporated by reference in their entirety with respect to the related technology.

Synthetic biology allows bioengineering of cells to synthesize novel valuable molecules such as renewable biofuels or anticancer drugs. However, traditional synthetic biology approaches involve ad-hoc engineering practices, which lead to long development times. Disclosed herein is a tool that leverages machine learning and probabilistic modeling techniques to guide synthetic biology in a systematic fashion (referred to herein as the Automated Recommendation Tool (ART)). A full mechanistic understanding of the biological system is not necessarily needed to use tool. Using sampling-based optimization, ART provides a set of recommended strains to be built in the next engineering cycle, alongside probabilistic predictions of their production levels.

Disclosed herein include systems for training a probabilistic predictive model for recommending experiment designs for a biology, such as synthetic biology, experiment. In some embodiments, a system for training a probabilistic predictive model for recommending experiment designs for a biology experiment comprises: non-transitory memory configured to store executable instructions; and a hardware processor in communication with the non-transitory memory, the hardware processor programmed by the executable instructions to: receive biology experimental data. The hardware processor can be programmed by the executable instructions to: generate training data from the biology experimental data. The training data can comprise a plurality of training inputs and corresponding reference outputs. Each of the plurality of training inputs can comprise training values of input variables. Each of the plurality of reference outputs can comprise a reference value of at least one response variable associated with a predetermined response variable objective. The hardware processor can be programmed by the executable instructions to: train, using the training data, a plurality of level-0 learners of a probabilistic predictive model for recommending experiment designs for biology. An input of each of the plurality of level-0 learners can comprise input values of the input variables. An output of each of the plurality of level-0 learners can comprise a predicted value of at least one response variable. The hardware processor can be programmed by the executable instructions to: train, using (i) predicted values of the at least one response variable determined using the plurality of level-0 learners for the training inputs of the plurality of training inputs, and (ii) the reference outputs of the plurality of reference outputs correspondence to the training inputs of the plurality of training inputs, a level-1 learner of the probabilistic predictive model for recommending experiment designs for biology comprising a probabilistic ensemble of the plurality of level-0 learners. An output of the level-1 learner can comprise a predicted probabilistic distribution of the at least one response variable.

Disclosed herein include methods for recommending experiment designs for a biology, such as synthetic biology, experiment. In some embodiments, a method for recommending experiment designs for a biology experiment is under control of a hardware processor and comprises: receiving a probabilistic predictive model for recommending experiment designs for biology comprising a plurality of level-0 learners and a level-1 learner. An input of each of the plurality of level-0 learners can comprise input values of the input variables. An output of each of the plurality of level-0 learners can comprise a predicted value of at least one response variable. The level-1 learner can comprise a probabilistic ensemble of the plurality of level-0 learners. An output of the level-1 learner can comprise a predicted probabilistic distribution of the at least one response variable. The plurality of level-0 learners and the level-1 learner can be trained using training data obtained from one or more cycles of a biology experiment comprising a plurality of training inputs and corresponding reference outputs. Each of the plurality of training inputs can comprise training values of input variables. Each of the plurality of reference outputs can comprise a reference value of at least one response variable associated with a predetermined response variable objective. The method can comprise: determining a surrogate function comprising an expected value of the level-1 learner, a variance of the level-1 learner, and an exploitation-exploration trade-off parameter. The method can comprise: determining, using the surrogate function, a plurality of recommended experiment designs, each comprising recommended values of the input variables, for a next cycle of the biology experiment for achieving a predetermined response variable objective associated with the at least one response variable.

Disclosed herein include methods for performing a biology (e.g., synthetic biology) experiment. In some embodiments, a method for performing a biology experiment comprises: performing one cycle of a biology experiment to obtain biology experimental data; training a probabilistic predictive model for recommending experiment designs for biology using the biology experimental data as described herein; determining a plurality of recommended experiment designs using the probabilistic predictive model; and performing a next cycle of the biology experiment using the plurality of recommended experiment designs. In some embodiments, a method for performing a biology experiment comprises, for each cycle of a plurality of cycles of a biology experiment: performing the cycle of the biology experiment to obtain biology experimental data for the cycle; training a probabilistic predictive model for recommending experiment designs for biology using84 the biology experimental data of the cycle and any prior cycle, if any, as described herein; determining a plurality of recommended experiment designs using the probabilistic predictive model; and performing a next cycle of the biology experiment using the plurality of recommended experiment designs.

### Automated Recommendation Tool

Synthetic biology aims to improve genetic and metabolic engineering by applying systematic engineering principles to achieve a previously specified goal. Synthetic biology encompasses, and goes beyond, metabolic engineering: it also involves non-metabolic tasks such as gene drives able to extinguish malaria-bearing mosquitoes or engineering microbiomes to replace fertilizers.

One of the synthetic biology engineering principles used to improve metabolic engineering is the Design-Build-Test-Learn (DBTL) cycle—a loop used recursively to obtain a design that satisfies the desired specifications (e.g., a particular titer, rate, yield or product). The DBTL cycle's first step is to design (D) a biological system expected to meet the desired outcome. That design is built (B) in the next phase from DNA parts into an appropriate microbial chassis using synthetic biology tools. The next phase involves testing (T) whether the built biological system indeed works as desired in the original design, via a variety of assays: e.g., measurement of production or/and 'omics (transcriptomics, proteomics, metabolomics) data profiling. It is extremely rare that the first design behaves as desired, and further attempts are typically needed to meet the desired specification. The Learn (L) step leverages the data previously generated to inform the next Design step so as to converge to the desired specification faster than through a random search process.

The Learn phase of the DBTL cycle has traditionally been the most weakly supported and developed, despite its critical importance to accelerate the full cycle. The reasons are multiple, although their relative importance is not entirely clear. Arguably, the main drivers of the lack of emphasis on the L phase are: the lack of predictive power for biological systems behavior, the reproducibility problems plaguing biological experiments, and the traditionally moderate emphasis on mathematical training for synthetic biologists.

Disclosed herein include a tool that leverages machine learning for synthetic biology's purposes: the Automated Recommendation Tool (ART). In some embodiments, ART combines machine learning with a novel Bayesian ensemble approach, in a manner that adapts to the particular needs of synthetic biology projects: e.g., low number of training instances, recursive DBTL cycles, and the need for uncertainty quantification. ART can provide machine learning capabilities in an easy-to-use and intuitive manner, and is able to guide synthetic biology efforts in an effective way.

In some embodiments, ART guides synthetic biology effectively in different typical metabolic engineering situations: high/low coupling of the heterologous pathway to host metabolism, complex/simple pathways, high/low number of conditions, high/low difficulty in learning pathway behavior. ART's ensemble approach can successfully guide the bioengineering process even in the absence of quantitatively accurate predictions. In some embodiments, ART's ability to quantify uncertainty is crucial to gauge the reliability of predictions and effectively guide recommendations towards the least known part of the phase space.

ART can be tailored to the synthetic biologist's needs in order to leverage the power of machine learning to enable predictable biology. This combination of synthetic biology with machine learning and automation has the potential to revolutionize bioengineering by enabling effective inverse design.

### Capabilities

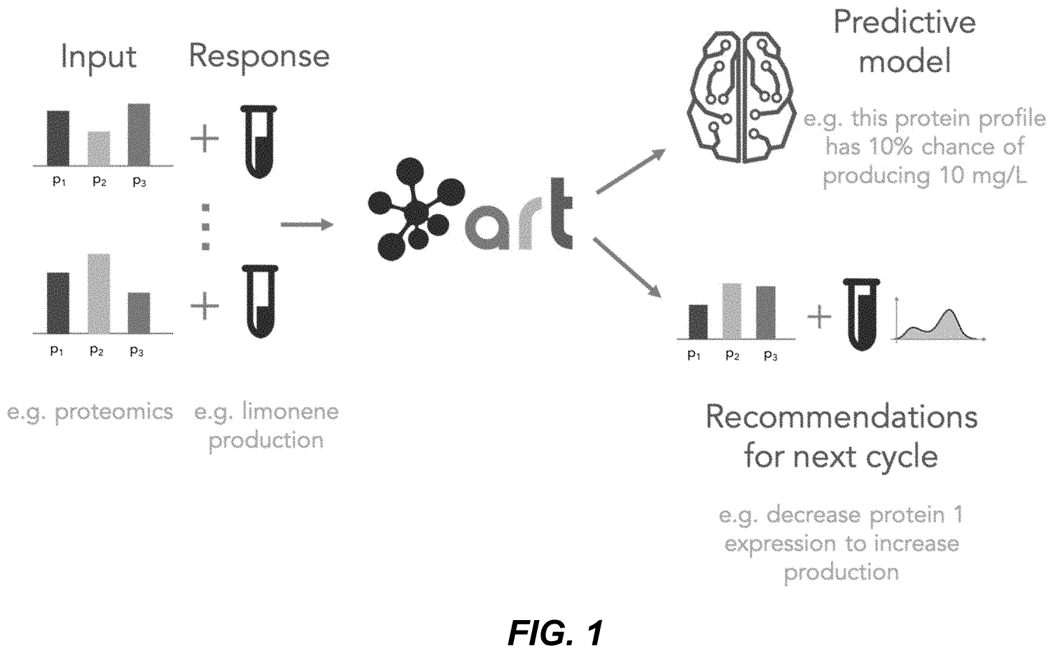

ART leverages machine learning to improve the efficacy of bioengineering microbial strains for the production of desired bioproducts (FIG. 1). ART can get trained on available data to produce a model capable of predicting the response variable (e.g., production of the jet fuel limonene) from the input data (e.g., proteomics data, or any other type of data that can be expressed as a vector). In some embodiments, ART uses this model to recommend new inputs (e.g., proteomics profiles) that are predicted to reach our desired goal (e.g., improve production). As such, ART can bridge the Learn and Design phases of a DBTL cycle.

FIG. 1. ART predicts the response from the input and provides recommendations for the next cycle. In some embodiments, ART uses experimental data to i) build a probabilistic predictive model that predicts response (e.g., production) from input variables (e.g., proteomics), and ii) uses this model to provide a set of recommended designs for the next experiment, along with the probabilistic predictions of the response.

ART can import experimental data and associated metadata stored in a repository, for example, in a standardized manner. Alternatively or additionally, ART can import files (e.g., .csv files) which contain experimental data and associated metadata. The files can be exported from a repository storing the experimental data and associated metadata.

By training on the provided data set, ART can build a predictive model for the response as a function of the input variables. Rather than predicting point estimates of the output variable, ART can provide the full probability distribution of the predictions. This rigorous quantification of uncertainty enables a principled way to test hypothetical scenarios in-silico, and to guide design of experiments in the next DBTL cycle. The Bayesian framework used to provide the uncertainty quantification useful for addressing the type of problems often encountered in metabolic engineering: sparse data which is expensive and time consuming to generate.

In some embodiments, with a predictive model at hand, ART can provide a set of recommendations expected to produce a desired outcome, as well as probabilistic predictions of the associated response. Some metabolic engineering objectives supported include maximization of the production of a target molecule (e.g., to increase Titer, Rate, and Yield (TRY)), its minimization (e.g., to decrease the toxicity), as well as specification objectives (e.g., to reach specific level of a target molecule for a desired beer taste profile). In some embodiments, ART leverages the probabilistic model to estimate the probability that at least one of the provided recommendations is successful (e.g., ART can improve the best production obtained so far), and derive how many strain constructions would be required for a reasonable chance to achieve the desired goal.

In some embodiments, ART is applied to problems with multiple output variables of interest. In some embodiments, the multiple output variables can have the same type of objective for all output variables. In some embodiments, the multiple output variables can have different types of objectives for the output variables. For example, ART can support maximization of one target molecule along with minimization of another.

### Mathematical Methodology

Learning from Data: A Predictive Model Through Machine Learning and a Bayesian Ensemble Approach

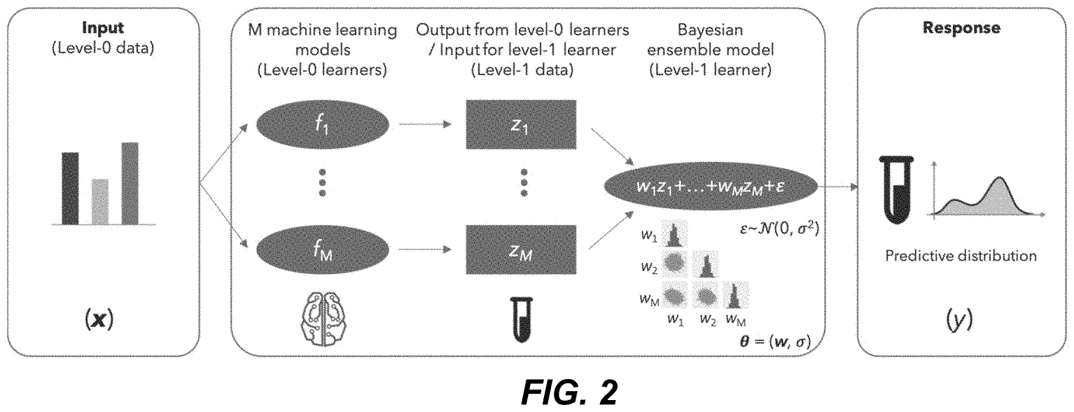

By learning the underlying regularities in experimental data, ART can provide predictions (FIG. 2). Training data can be used to statistically link an input (e.g., features or independent variables) to an output (e.g., response or dependent variables) through models that are expressive enough to represent almost any relationship. After this training, the models can be used to predict the outputs for inputs that the model has never seen before.

FIG. 2. ART provides a probabilistic predictive model of the response (e.g., production). In some embodiments, ART combines several machine learning models from the with a novel Bayesian approach to predict the probability distribution of the output. In some embodiments, the input to ART is proteomics data (or any other input data in vector format: transcriptomics, gene copy, etc.), referred to herein as level-0 data. This level-0 data can be used as input for a variety of machine learning models (level-0 learners) that produce a prediction of production for each model (zᵢ) by each level-0 learner. These predictions (level-1 data) can be used as input for the Bayesian ensemble model (level-1 learner), which weighs these predictions (or the level-0 learners that produce the predictions) differently depending on each level-0 learner's ability to predict the training data. The weights wᵢ and the variance a can be characterized through probability distributions, giving rise to a final prediction in the form of a full probability distribution of response levels.

ART can sidestep the challenge of model selection by using an ensemble model approach. This approach takes the input of various different models and has them “vote” for a particular prediction. Each of the ensemble members can be trained to perform the same task, and their predictions can be combined to achieve an improved performance. In some embodiments, an ensemble model used can either use a set of different models (heterogeneous case) or the same models with different parameters (homogeneous case). ART can be based on a heterogeneous ensemble learning approach that uses reasonable hyperparameters for each of the model types, rather than specifically tuning hyperparameters for each of them.

ART can be based on a novel probabilistic ensemble approach where the weight of each ensemble model is considered a random variable, with a probability distribution inferred by the available data. This method does not require the individual models to be probabilistic in nature. The weighted ensemble model approach can produce a simple, yet powerful, way to quantify both epistemic and aleatoric uncertainty—a critical capability when dealing with small data sets in biological research. The ensemble approach can be used for the single response variable problems. Alternatively or additionally, the ensemble approach can be used for the multiple variables case. Using a common notation in ensemble modeling, the following levels of data and learners (see FIG. 2) can be defined.

In some embodiments, level-0 data ( [symbol] ) represent the historical data including N known instances of inputs and responses, that is [symbol] ={(xₙ, yₙ), n=1, . . . , N}, where x∈ [symbol] ⊆ [symbol] ^{D} is the input comprised of D features and y∈ [symbol] is the associated response variable. For the sake of cross-validation, the level-0 data are further divided into validation ( [symbol] ^{(k)}) and training sets ( [symbol] ^{(-k)}. [symbol] ⊂ [symbol] is the kth fold of a K-fold cross-validation obtained by randomly splitting the set [symbol] into K almost equal parts, and [symbol] ^{(-k)}= [symbol] \ [symbol] ^{(k)} is the set [symbol] without the kth fold [symbol] ^{(k)}. Note that these sets do not overlap and cover the full available data; that is [symbol] ^{(k}^{ᵢ}⁾∩ [symbol] ^{(k}^{ⱼ}⁾=ø,i≠j and ∪ᵢ [symbol] ^{(k}^{ᵢ}⁾= [symbol] .

In some embodiments, level-0 learners (fₘ) includes M base learning algorithms fₘ, m=1, . . . , M used to learn from level-0 training data [symbol] ^{(-k)}. Non-limiting exemplary level-0 learners can include random forest, neural network, support vector regressor, kernel ridge regressor, K-NN regressor, Gaussian process regressor, gradient boosting regressor, as well as TPOT (tree-based pipeline optimization tool). In some embodiments, TPOT uses genetic algorithms to find the combination of the 11 different regressors and 18 different preprocessing algorithms.

In some embodiments, level-1 data ( [symbol] _{cv}) are data derived from [symbol] by leveraging cross-validated predictions of the level-0 learners. More specifically, level-1 data can be the set [symbol] _{CV}={(zₙ, yₙ), n=1, . . . , N}, where zₙ=(z₁ₙ . . . , z_{Mn}) are predictions for level-0 data (xₙ ∈ [symbol] ^{(k)}) of level-0 learners (fₘ^{(-k}) trained on observations which are not in fold k ( [symbol] ^{(-k)}), e.g., zₘₙ=fₘ^{(-k)} (xₙ), m=1, . . . , M.

In some embodiments, the level-1 learner (F), or a metalearner, is a linear weighted combination of level-0 learners, with weights wₘ, m=1, . . . , M being random variables that are non-negative and normalized to one. Each wₘ can be interpreted as the relative confidence in model m. Given an input x the response variable y can be modeled as:

F:y=w^{T}f(x)+ε,ε˜ [symbol] (0,σ²), (1)

where w=[w₁ . . . w_{M}]^{T} is the vector of weights such that Σwₘ=1, wₘ≥0, f(x)=[f₁(x) . . . f_{M}(x)]^{T} is the vector of level-0 learners, and ε is a normally distributed error variable with a zero mean and standard deviation σ. The unknown ensemble model parameters can be denoted as θ≡(w, σ), constituted of the vector of weights and the Gaussian error standard deviation. The parameters θ can be obtained by training F on the level-1 data [symbol] _{CV}. In some embodiments, the final model F for generating predictions for new inputs uses these θ, inferred from level-1 data [symbol] _{CV}, and the base learners fₘ, m=1, . . . , M trained on the full original data set [symbol] , rather than only on the level-0 data partitions [symbol] ^{(-k)}.

A single point estimate of ensemble model parameters θ that best fit the training data is provided. Alternatively or additionally, a joint probability distribution which quantifies the probability that a given set of parameters explains the training data can be provided by the Bayesian model. This Bayesian approach makes possible to not only make predictions for new inputs but also examine the uncertainty in the model. Model parameters θ can be characterized by full posterior distribution p(θ| [symbol] ) that can be inferred from level-1 data. In some embodiments, ART samples from the full posterior distribution p(θ|D) using the Markov Chain Monte Carlo (MCMC) technique, which samples the parameter space with a frequency proportional to the desired posterior p(θ|D).

In some embodiments, the ensemble model produces a full distribution that takes into account the uncertainty in model parameters. For a new input x* (not present in [symbol] ), the ensemble model F can provide the probability that the response is y, when trained with data [symbol] (the full predictive posterior distribution):

p(y|x*, [symbol] )=∫p(y|x*,θ)p(θ| [symbol] )dθ=∫ [symbol] (y;w^{T}f,σ²)p(θ| [symbol] )dθ, (2)

where p(y|x*, θ) is the predictive distribution of y given input x* and model parameters θ, p(θ| [symbol] ) is the posterior distribution of model parameters given data [symbol] , and f≡f(x*) for the sake of clarity.

Optimization: Suggesting Next Steps

In some embodiments, the optimization phase leverages the predictive model described in the previous section to find inputs with corresponding outputs predicted to be closer to the objective (e.g., maximize or minimize response, or achieve a desired response level). In mathematical terms, the optimization phase can look for a set of Nᵣ suggested inputs xᵣ∈ [symbol] ; r=1, . . . , Nᵣ, that optimize the response with respect to the desired objective. A process with the following characteristics can be desirable:

i) optimizing the predicted levels of the response variable;

ii) being able to explore the regions of input phase space associated with high uncertainty in predicting response, if desired; and

iii) providing a set of different recommendations, rather than only one.

In some embodiments, the optimization problem is defined formally as

$$\begin{matrix}arg {max}_{x} G ( x ) \\ s . t . x ∈ ℬ\end{matrix} ,$$

where the surrogate function G(x) is defined as:

$$G ( x ) = \{ \begin{matrix}( 1 - α ) 𝔼 ( y ) + {αVar ( y )}^{1 / 2} & ( maximization case ) \\ - ( 1 - α ) 𝔼 ( y ) + {αVar ( y )}^{1 / 2} & ( minimization case ) \\ - ( 1 - α ) \vert \vert 𝔼 ( y ) - {y}^{*} {\vert \vert}_{2}^{2} + {αVar ( y )}^{1 / 2} & ( specification case )\end{matrix} \qquad ( 3 )$$

depending on which mode ART is operating in. Here, y* is the target value for the response variable, y=y(x), [symbol] (y) and Var(y) denote the expected value and variance respectively, |x|₂²=Σᵢxᵢ² denotes Euclidean distance, and the parameter α∈[0,1] represents the exploitation-exploration trade-off. The constraint such that (s.t.) x∈ [symbol] tor

$$arg {max}_{x} G ( x )$$

characterizes the lower and upper bounds for each input feature (e.g., protein levels cannot increase beyond a given, physical, limit). These bounds can be provided by a user. Alternatively or additionally, default values of the bounds can be computed from the input data.

In some embodiments, Bayesian optimization, which addresses requirements i) and ii), is used: optimization of a parametrized surrogate function which accounts for both exploitation and exploration. In some embodiments, the objective function G(x) takes the form of the upper confidence bound given in terms of a weighted sum of the expected value and the variance of the response (parametrized by α, Eq. 3). This scheme accounts for both exploitation and exploration. For example, for the maximization case for α=1 G(x)=Var(y)^{1/2}, so the algorithm suggests next steps that maximize the response variance, thus exploring parts of the phase space where the model shows high predictive uncertainty. For α=0, G(x)=E(y), the algorithm suggests next steps that maximize the expected response, thus exploiting our model to obtain the best response. Intermediate values of α can produce a mix of both behaviors. α can be set to values slightly smaller than 1 (e.g., 0.9) for early-stage DBTL cycles, thus allowing for more systematic exploration of the space so as to build a more accurate predictive model in the subsequent DBTL cycles. If the objective is purely to optimize the response, α can be set to 0, for example.

In some embodiments, to address (iii), as well as to avoid entrapment in local optima and search the phase space more effectively, the optimization problem is solved through sampling. Samples can be drawn from a target distribution defined as

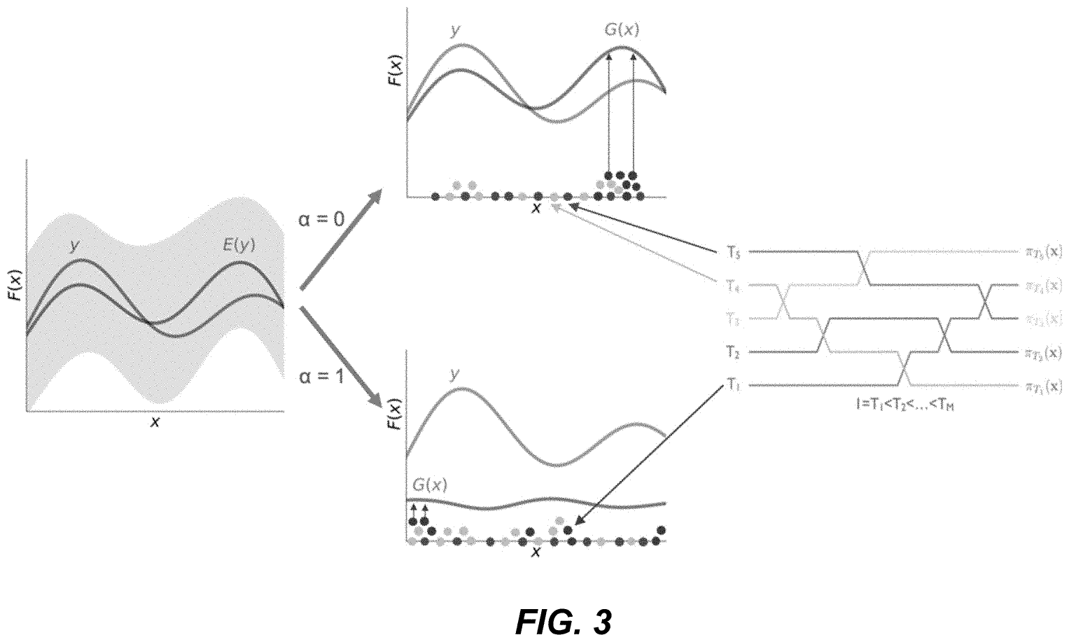

π(x)∝ exp(G(x))p(x), (4)

where p(x)= [symbol] ( [symbol] ) can be interpreted as the uniform ‘prior’ on the set [symbol] , and exp(G(x)) as the ‘likelihood’ term of the target distribution. Sampling from π implies optimization of the function G, since the modes of the distribution π correspond to the optima of G. MCMC can be used for sampling. If the target distribution displays more than one mode, there is a possibility that a Markov chain gets trapped in one of them. In some embodiments, to make the chain explore all areas of high probability, ART can “flatten/melt down” the roughness of the distribution by tempering. For example, the Parallel Tempering algorithm can be used for optimization of the objective function through sampling, in which multiple chains at different temperatures are used for exploration of the target distribution (FIG. 3).

FIG. 3. ART chooses recommendations for next steps by sampling the modes of a surrogate function in some embodiments. The leftmost panel shows the true response y (e.g., biofuel production to be optimized) as a function of the input x (e.g., proteomics data), as well as the expected response E(y) after several DBTL cycles, and its 95% confidence interval (blue). The objective can be to explore the phase space where the model is least accurate or to exploit the predictive model to obtain the highest possible predicted responses. Depending on the objective, a surrogate function G(x) (Eq. 3), where the exploitation-exploration parameter is α=0 (pure exploitation), α=1 (pure exploration) or anything in between, can be optimized. Parallel-Tempering-based MCMC sampling (center and right side) can produce sets of vectors x (colored dots) for different “temperatures”: higher temperatures (red) explore the full phase space, while lower temperature chains (blue) concentrate in the nodes (optima) of G(x). Exchange between different “temperatures” provides more efficient sampling without getting trapped in local optima. Final recommendations (blue arrows) to improve response can be provided from the lowest temperature chain, and chosen such that the final recommendations are not too close to each other and to experimental data (e.g., at least 20% difference).

Choosing Recommendations for the Next Cycle

In some embodiments, after drawing a certain number of samples from π(x), recommendations for the next cycle are chosen. The chosen recommendations can be sufficiently different from each other as well as from the input experimental data. To do so, first ART can find a sample with optimal G(x) (G(x) values can be already calculated and stored). This sample can be accepted as a recommendation if there is at least one feature whose value is different by at least a factor γ (e.g., 20% difference, γ=0.2) from the values of that feature in all data points x∈ [symbol] . Otherwise, for the next optimal sample, ART can check the same condition. This procedure can be repeated until the desired number of recommendations are collected, and the condition involving γ is satisfied for all previously collected recommendations and all data points. In case all draws are exhausted without collecting the sufficient number of recommendations, ART can decrease the factor γ and repeat the procedure from the beginning.

Markov Chain Monte Carlo Sampling

The posterior distribution p(θ| [symbol] ) (probability that the parameters θ fit the data [symbol] , used in Eq. 2) can be obtained by applying Bayes' formula with the posterior distribution being defined through a prior p(θ) and a likelihood function p( [symbol] |θ) as

p(θ| [symbol] )∝p( [symbol] |θ)p(θ).

The prior can be defined to be p(θ)=p(w)p(σ), where p(w) is a Dirichlet distribution with uniform parameters, which can ensure the constraint on weights (the weights add to one) is satisfied, and p(σ) is a half normal distribution with mean and standard deviation set to 0 and 10, respectively. The likelihood function follows directly from Eq. 1 as

$$p ( 𝒟 \vert θ ) = {\prod }_{n = 1}^{N} p ( {y}_{n} \vert {x}_{n} , θ ) , \\ p ( {y}_{n} \vert {x}_{n} , θ ) = \frac{1}{σ \sqrt{2 π}} exp \{ - \frac{{( {y}_{n} - {w}^{T} f ( {x}_{n} ) )}^{2}}{2 {σ}^{2}} \} .$$

Expected Value and Variance for Ensemble Model

From Eq. 1, the following can be computed: the expected value

[symbol]

(y)= [symbol] (w^{T}f+ϵ)= [symbol] (w)^{T}f (5)

and variance

Var(y)=f^{T}Var(w)f+Var(ε) (6)

of the response, which can be used in the optimization phase in order to create the surrogate function G(x) (Eq. 3). The expected value and variance of w and ε can be estimated through sample mean and variance using samples from the posterior distribution p(θ| [symbol] ). p(y|x*,θ) can be modeled to be Gaussian (Eq. 1).

Input Space Set

[symbol]

The bounds for the input space [symbol] for G(x) (Eq. 3) can be provided by the use. Alternatively or additionally, default values can be computed from the input data defining the feasible space as:

$$ℬ = \{ \tilde{x} ∈ {ℝ}^{D} \vert {L}_{d} - {Δ}_{d} \leq {\tilde{x}}^{d} \leq {U}_{d} + {Δ}_{d} , d = 1 , … , D \} \\ {Δ}_{d} = ( {U}_{d} - {L}_{d} ) ϵ ; {U}_{d} = {m}_{1 \leq n \leq N} ( {x}_{n}^{d} ) ; {L}_{d} = {m}_{1 \leq n \leq N} ( {x}_{n}^{d} ) . \\ ( {x}_{n} , {y}_{n} ) ∈ 𝒟 , n = 1 , … , N \qquad ( 7 )$$

Without being bounded by any particular theory, the restriction of input variables to the set [symbol] reflects the assumption that the predictive models performs accurately enough only on an interval that is enlarged by a factor ϵ around the minimum and maximum values in the data set (e.g., ϵ=0.05).

Success Probability Calculation

The probabilistic model can enable estimating the probability of success for the provided recommendations, such as the probability that a single recommendation is successful and the probability that at least one recommendation of several provided is successful. Success can be defined differently for each of the three cases considered in Eq. 3: maximization, minimization and specification. For maximization, success can involve obtaining a response y higher than the success value y* defined by the user (e.g., the best production so far improved by a factor of 20%). For minimization, success can involve obtaining a response lower than the success value y*. For the specification case, success can involve obtaining a response that is as close as possible to the success value y*.

Success for response y can be defined through the set [symbol] ={y|y˜p [symbol] (y)}, where the probability distribution for success is

$${p}_{𝒮} ( y ) = \{ \begin{matrix}𝒰 ( {y}^{*} , U ) & ( maximization case ) \\ 𝒰 ( L , {y}^{*} ) & ( minimization case ) \\ 𝒩 ( {y}^{*} , {σ}_{{y}^{*}}^{2} ) & ( specification case )\end{matrix} , \qquad ( 8 )$$

where [symbol] is the uniform distribution ( [symbol] (a, b)=1/(b−a) if a<y<b; 0 otherwise), L and U are its corresponding lower and upper bounds, and σ_{y*}² is the variance of the normal distribution [symbol] around the target value y* for the specification case.

The probability that a recommendation succeeds can be given by integrating the probability that input x^{r} gives a response y (full predictive posterior distribution from Eq. 2), times the probability that response y is a success

p( [symbol] |x^{r})=∫ [symbol] (y)p(y|x^{r}, [symbol] )dy.

This success probability can be approximated using draws from the posterior predictive distribution as

$$p ( S \vert {x}^{r} ) \approx \{ \begin{matrix}\frac{1}{{N}_{s}} {\sum }_{i = 1}^{{N}_{s}} {𝕀}_{𝒮} ( {y}_{i} ) & ( \frac{maximization}{minimization case} ) \\ \frac{1}{{N}_{s}} {\sum }_{i = 1}^{{N}_{s}} 𝒩 ( {y}_{i} ; {y}^{*} , {σ}_{{y}^{*}}^{2} ) & ( specification case )\end{matrix} , \qquad ( 9 )$$

where yᵢ˜p(y|x^{r}, [symbol] ), i=1, . . . , Nₛ, and [symbol] (y)=1 if y [symbol] , 0 if y∉ [symbol] .

In case of multiple recommendations {x^{r}}≡{x^{r}}ᵣ₌₁^{N}^{ᵣ}, ART can provide the probability of success for at least one of the recommendations only for maximization and minimization types of objectives. This probability can be calculated as one minus the probability p( [symbol] |{x^{r}}) that all recommendations fail, where

$$p ( ℱ \vert \{ {x}^{r} \} ) \approx \frac{1}{{N}_{s}} {\sum }_{i = 1}^{{N}_{s}} {𝕀}_{ℱ} ( \{ {y}_{i}^{r} \} ) , \\ \{ {y}_{i}^{r} \} ∼ p ( y \vert \{ {x}^{r} \} , 𝒟 ) , i = 1 , … , {N}_{s} , r = 1 , … , {N}_{r} ,$$

and the failure set [symbol] ={{y^{r}}|y^{r}∉ [symbol] , ∀r=1, . . . , Nᵣ} includes outcomes that are not successes for all of the recommendations. Since the chosen recommendations are not necessarily independent, ART can sample {yᵢ^{r}} jointly for all {x^{r}}, that is i-th sample has the same model parameters (wᵢ, σᵢ, εᵢⱼ˜ [symbol] (0,σᵢ²) from Eq. 1) for all recommendations.

Multiple Response Variables

In some embodiments, for multiple response variable problems (e.g., trying to hit a predetermined value of metabolite a and metabolite b simultaneously), the response variables can be conditionally independent given input vector x, and ART can build a separate predictive model pⱼ(yⱼ|x, [symbol] ) for each variable yⱼ, j=1, . . . , J. The objective function for the optimization phase can be defined as

G(x)=(1−α)Σⱼ₌₁^{J} [symbol] (yⱼ)+αΣⱼ₌₁^{J} Var(yⱼ)^{1/2}

in case of maximization, and analogously adding the summation of expectation and variance terms in the corresponding functions for minimization and specification objectives (Eq. 3). The probability of success for multiple variables can then defined as

p( [symbol] ₁, . . . , [symbol] ⱼ|x)=Πⱼ₌₁^{J}p( [symbol] ⱼ|x^{r})

In some embodiments, correlations among multiple response variables can exist. In some embodiments, correlations among multiple response variables do not exist.

ART can be a tool that not only provides synthetic biologists easy access to machine learning techniques, but can also systematically guide bioengineering and quantify uncertainty. ART can take as input a set of vectors of measurements (e.g., a set of proteomics measurements for several proteins, or transcripts for several genes) along with their corresponding systems responses (e.g., associated biofuel production) and provide a predictive model, as well as recommendations for the next round (e.g., new proteomics targets predicted to improve production in the next round).

In some embodiments, ART combines the machine learning methods with a novel Bayesian ensemble approach that can leverage a diverse set of models and MCMC sampling, and is optimized for the conditions encountered in metabolic engineering: small sample sizes, recursive DBTL cycles and the need for uncertainty quantification. ART's approach involves an ensemble where the weight of each model is considered a random variable with a probability distribution inferred from the available data. In some embodiments, ART does not require the ensemble models to be probabilistic in nature. This weighted ensemble model can produce a simple, yet powerful, approach to quantify uncertainty (FIG. 2). In some embodiments, ART is adapted to synthetic biology's special needs and characteristics. In some embodiments, ART is general enough that it is easily applicable to other problems of similar characteristics.

ART is a useful tool in guiding bioengineering. In some embodiments, ART has one or more of the following: inclusion of a pathway cost ($) function, inclusion of classification problems, inclusion of additional optimization methods (e.g., to include the case of discrete input variables), incorporation of covariance of level-0 models into the ensemble model, and incorporation of input space errors into learners.

ART can provide effective decision-making in the context of synthetic biology and facilitates the combination of machine learning and automation that can disrupt synthetic biology. Combining ML with recent developments in macroscale lab automation, microfluidics and cloud labs can enable self-driving laboratories, which augment automated experimentation platforms with artificial intelligence to facilitate autonomous experimentation. Fully leveraging AI and automation can catalyze a similar step forward in synthetic biology as CRISPR-enabled genetic editing, high-throughput multi-omics phenotyping, and exponentially growing DNA synthesis capabilities have produced in the recent past.

### Training and Using a Probabilistic Predictive Ensemble Model for Recommending Experiment Designs for Biology

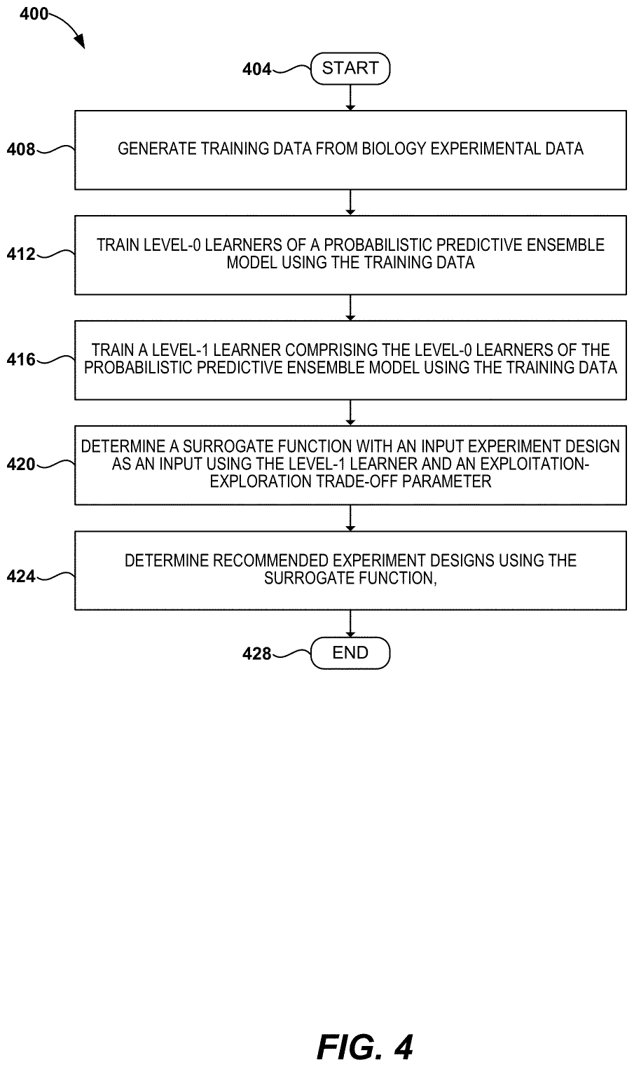

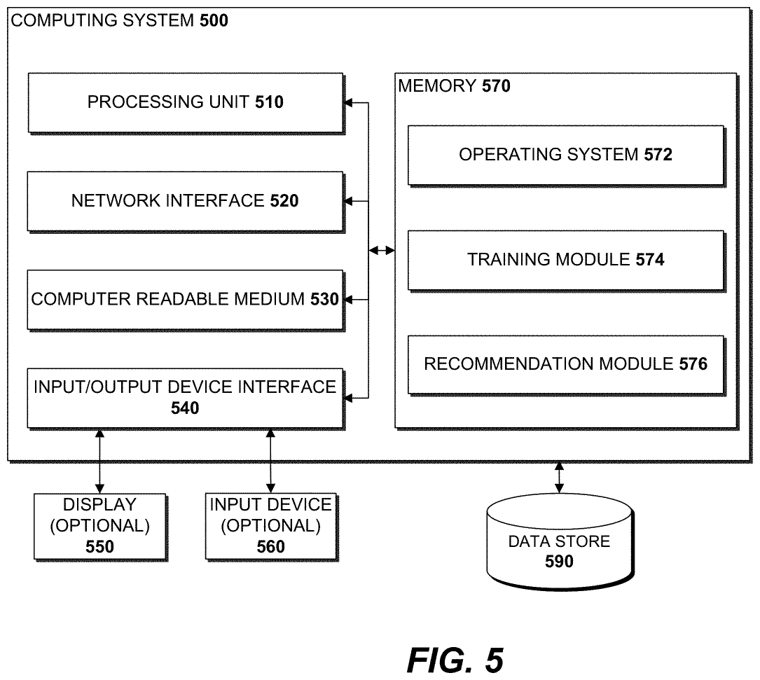

FIG. 4 is a flow diagram showing an exemplary method 400 of training and using a probabilistic predictive ensemble model for recommending experiment designs for biology. The method 400 may be embodied in a set of executable program instructions stored on a computer-readable medium, such as one or more disk drives, of a computing system. For example, the computing system 500 shown in FIG. 5 and described in greater detail below can execute a set of executable program instructions to implement the method 400. When the method 400 is initiated, the executable program instructions can be loaded into memory, such as RAM, and executed by one or more processors of the computing system 500. Although the method 400 is described with respect to the computing system 500 shown in FIG. 5, the description is illustrative only and is not intended to be limiting. In some embodiments, the method 400 or portions thereof may be performed serially or in parallel by multiple computing systems.

After the method 400 begins at block 404, the method 400 proceeds to block 408, where a computing system (e.g., the computing system 500 shown in FIG. 5) can generate training data from synthetic biology experimental data. The computing system can receive the synthetic biology experimental data and generate the training data from the synthetic biology experimental data received. The training data (e.g., level-0 data [symbol] above) can comprise a plurality of training inputs and corresponding reference outputs (e.g., {(xₙ, yₙ), n=1, . . . , N} above). Each of the plurality of training inputs (e.g., {xₙ, n=1, . . . , N}) can comprise training values of input variables. Each of the plurality of reference outputs (e.g., {yₙ, n=1, . . . , N}) can comprise a reference value of at least one response variable associated with a predetermined response variable objective.

In some embodiments, the synthetic biology experimental data comprise experimental data obtained from one or more cycles of a synthetic biology experiment, such as 1 cycle, 2 cycles, 3 cycles, 4 cycles, 5 cycles, 6 cycles, 7 cycles, 8 cycles, 9 cycles, 10 cycles, 20 cycles, or more, of the synthetic biology experiment. The synthetic biology experimental data can comprise experimental data obtained from one, or each, prior cycle of a synthetic biology experiment. The synthetic biology experimental data can comprise experimental data not obtained from any cycle of a synthetic biology experiment. For example, the experiment data can be from one or more biology experiments, not a synthetic biology experiment.

In some embodiments, the synthetic biology experimental data comprise genomics data, transcriptomics data, epigenomics, proteomics data, metabolomics data, microbiomics data, or a combination thereof. The synthetic biology experimental data can comprise multiomics data. In some embodiments, the synthetic biology experimental data comprise metabolic engineering experimental data and/or genetic engineering experimental data. The predetermined response variable objective can comprise a metabolic engineering objective and/or a genetic engineering objective. The synthetic biology experimental data can comprise experimental data of one or more pathways. One, or each, of the one or more pathways can comprise, or comprise about, a number of proteins (e.g., 2, 3, 4, 5, 6, 7, 8, 9, 10, 20, 30, 40, 50, 100, or more proteins) and/or a number of genes (e.g., 2, 3, 4, 5, 6, 7, 8, 9, 10, 20, 30, 40, 50, 100, or more genes). The one or more pathways can comprise one or more metabolic pathways and/or one or more signaling pathways.

In some embodiments, the synthetic biology experimental data is obtained from one or more cells, or organisms, of a species. At least one of the one or more pathways can be endogenous (e.g., internal) to the one or more cells, or organisms. At least one of the one or more pathways can be related to (e.g., tied to) a pathway of the one or more cells, or organisms. At least one of the one or more pathways can have high coupling to one, or each, pathway of the one or more cells, or organisms. At least one of the one or more pathways can have high coupling to metabolism of the one or more cells, or organisms. At least one of the one or more pathways can have low coupling to one, or each, pathway of the one or more cells, or organisms. At least one the one or more pathways can have low coupling to metabolism of the one or more cells, or organisms. At least one of the one or more pathways can be exogenous (e.g., external) to the one or more cells, or organisms. The species can be a prokaryote, a bacterium, E. Coli, an archaeon, an eukaryote, a yeast, a virus, or a combination thereof.

In some embodiments, the synthetic biology experimental data is sparse. For example, the synthetic biology experimental data can comprise about 50 training inputs. A number of the plurality of training inputs can be a number of experimental conditions, a number of strains, a number of replicates of a strain of the strains, or a combination thereof. For example, the number of the plurality of training inputs can be the number of experiment conditions. For example, the number of the plurality of training inputs can be the number of strains (or experiment conditions) multiplied by the number of replicates per strain (or experiment condition). A number of the plurality of training inputs can be, or be about, 2, 5, 10, 15, 20, 30, 40 50, 100, 200, 300, 400, 500, 1000, 2000, 3000, 4000, 5000, 10000, or more. The training data can comprise a plurality of training vector representing the plurality of training inputs. A number of the input variables (or a dimension of a training input, or a dimension of an input of a level-0 learner) can be, or be about, 2, 5, 10, 15, 20, 30, 40 50, 100, 200, 300, 400, 500, 1000, 2000, 3000, 4000, 5000, 10000, or more.

In some embodiments, one, or each, of the plurality of input variables comprises a promoter sequence, an induction time, an induction strength, a ribosome binding sequence, a copy number of a gene, a transcription level of a gene, an epigenetics state of a gene, a splicing state of a gene, a level of a protein, a post translation modification state of a protein, a level of a molecule (e.g., a target molecule or a molecule of interest), an identity of a molecule, a level of a microbe, a state of a microbe, a state of a microbiome, a titer, a rate, a yield, or a combination thereof. The molecule can be an inorganic molecule, an organic molecule, a protein, a polypeptide, a carbohydrate, a sugar, a fatty acid, a lipid, an alcohol, a fuel, a metabolite, a drug, an anticancer drug, a biofuel molecule, a flavoring molecule, a fertilizer molecule, or a combination thereof.

In some embodiments, the at least one response variable comprises a copy number of a gene, a transcription level of a gene, an epigenetics state of a gene, a level of a protein, a post translation modification state of a protein, a level of a molecule, an identity of a molecule, a level of a microbe, a state of a microbe, a state of a microbiome, a titer, a rate, a yield, or a combination thereof. The molecule can be an inorganic molecule, an organic molecule, a protein, a polypeptide, a carbohydrate, a sugar, a fatty acid, a lipid, an alcohol, a fuel, a metabolite, a drug, an anticancer drug, a biofuel molecule, a flavoring molecule, a fertilizer molecule, or a combination thereof.

In some embodiments, the at least one response variable comprises two or more response variables (e.g., 2, 3, 4, 5, 6, 7, 8, 9, 10, 20, 30, 40, 50, 60, 70, 80, 90, 100, or more, response variables) each associated with a predetermined response variable objective. The predetermined response variable objectives of all of the two of more response variables can be identical. The predetermined response variable objectives of two response variables of the two of more response variables can be identical. The predetermined response variable objectives of two response variables of the two of more response variables can different. The predetermined response variable objectives of all of the two of more response variables can be identical. The predetermined response variable objective can comprise a maximization objective, a minimization objective, or a specification objective. The predetermined response variable objective can comprise maximizing the at least one response variable, minimizing the at least one response variable, or adjusting the at least one response variable to a predetermined value of the at least one response variable.

The method 400 proceeds from block 408 to block 412, where the computing system can train, using the training data, a plurality of level-0 learners (e.g., fₘ, m=1, . . . , M above) of a probabilistic predictive model for recommending experiment designs for synthetic biology. An input of each of the plurality of level-0 learners can comprise input values of the input variables. An output of each of the plurality of level-0 learners can comprise a predicted value of at least one response variable.

In some embodiments, two level-0 learners of the plurality of level-0 learners comprise machine learning models of an identical type with different parameters. No two level-0 learners of the plurality of level-0 learners can comprise machine learning models of an identical type. The plurality of level-0 learners can comprise a probabilistic machine learning model. The plurality of level-0 learners can comprise no probabilistic machine learning model. The plurality of level-0 learners can comprise a non-probabilistic machine learning model. The plurality of level-0 learners can comprise a deep learning model (e.g., a deep neural network). The plurality of level-0 learners can comprise no deep learning model. The plurality of level-0 learners can comprise a non-deep learning model. The plurality of level-0 learners can comprise a supervised machine learning model. The plurality of level-0 learners can comprise a random forest, a neural network, a support vector regressor, a kernel ridge regressor, a K-NN regressor, a Gaussian process regressor, a gradient boosting regressor, a tree-based pipeline optimization tool (TPOT), or a combination thereof. The plurality of level-0 learners can comprise, or comprise about, 2, 3, 4, 5, 6, 7, 8, 9, 10, 20, 30, 40, 50, 100, or more, machine learning models.

The method 400 proceeds from block 412 to block 416, where the computing system can train, using (i) predicted values (e.g., zₙ above) of the at least one response variable determined using the plurality of level-0 learners for the training inputs of the plurality of training inputs, and (ii) the reference outputs (e.g., yₙ above) of the plurality of reference outputs correspondence to the training inputs of the plurality of training inputs, a level-1 learner (e.g., F above) of the probabilistic predictive model for recommending experiment designs for synthetic biology comprising a probabilistic ensemble (e.g., F:γ=w^{T}f(x)+ε,ε˜ [symbol] (0,σ²) in equation (1) above) of the plurality of level-0 learners (e.g., f(x)=[f₁(x) . . . f_{M}(x)]^{T}). An output of the level-1 learner can comprise a predicted probabilistic distribution of the at least one response variable.

In some embodiments, to train the plurality of level-1 learner, the hardware processor is programmed by the executable instructions to: determine, using the plurality of level-0 learners, the predicted values of the at least one response variable (e.g., zₙ above) for training inputs of the plurality of training inputs. The level-1 learner can comprise a Bayesian ensemble of the plurality of level-0 learners.

In some embodiments, parameters of the ensemble of the plurality of level-0 learners comprises (i) a plurality of ensemble weights (e.g., w=[w₁ . . . w_{M}]^{T} above) and (ii) an error variable distribution (e.g., ε˜ [symbol] (0,σ²) in equation (1) above) of the ensemble or a standard deviation of the error variable distribution of the ensemble. The error variable distribution of the ensemble of the plurality of level-0 learners can comprise a normally distributed error variable. The error variable distribution of the ensemble can have a mean of zero. All ensemble weights of the plurality of ensemble weights can be normalized (e.g., summed) to 1. One, or each, ensemble weight of the plurality of ensemble weights can be non-negative. An ensemble weight of the plurality of ensemble weights can indicate a relative confidence of the level-0 learner of the plurality of level-0 learners weighted by the weight.

In some embodiments, the level-1 learner comprises a weighted combination of the plurality of level-0 learners with level-0 learners of the plurality of level-0 learners weighed by weights of the plurality of ensemble weights. The level-1 learner can comprise a weighted linear combination of the plurality of level-0 learners with level-0 learners of the plurality of level-0 learners weighed by weights of the plurality of ensemble weights.

In some embodiments, the computing system can generate a first non-empty subset of the training data (e.g., [symbol] ^{(-k)} above). The computing system can generate a second non-empty subset of the training data (e.g., [symbol] ^{(k)} above). The computing system can generate the first subset and/or second subsect of the training data randomly, semi-randomly, or non-randomly. The first subset of the training data and the second subset of the training data can be non-overlapping. The computing system can train, using the first subset of the training data, the plurality of level-0 learners.

The computing system can train, using (i) the predicted values (e.g., zₙ in level-1 data [symbol] _{CV}={(zₙ, yₙ), n=1, . . . , N} above) of the at least one response variable determined using the plurality of level-0 learners for the training inputs of the second subset of the training data, and (ii) the corresponding reference outputs (e.g., yₙ in level-1 data [symbol] _{CV}={(zₙ,yₙ), n=1, . . . , N} above) of the second subset of the training data corresponding to the training inputs of the second subset of the training data, the plurality of level-1 learners. In some embodiments, the computing system can train or retrain, using all training inputs and corresponding reference outputs of the training data, the plurality of level-0 learners of the probabilistic predictive model for recommending experiment designs for synthetic biology. For example, the final model F for generating predictions for new inputs can use (a) the θ inferred from level-1 data [symbol] _{CV} and (b) the base learners fₘ, m=1, . . . , M trained on the full original data set [symbol] , rather than only on the level-0 data partitions [symbol] ^{(-k)}.

In some embodiments, the computing system can determine a posterior distribution of the ensemble parameters given the training data or the second subset of the training data. For example, a joint probability distribution can quantify the probability that a given set of parameters explains the training data can be provided by the Bayesian model. Model parameters θ can be characterized by full posterior distribution p(θ| [symbol] ) that can be inferred from level-1 data. The computing system can determine (i) a probability distribution of the training data or the second subset of the training data given the ensemble parameters or a likelihood function of the ensemble parameters given the training data of the second subset of the training data (e.g., p( [symbol] |θ) above), and (ii) a prior distribution of the ensemble parameters (e.g., p(θ). Above). The computing system can sample a space of the ensemble parameters with a frequency proportional to a desired posterior distribution. For example, Markov Chain Monte Carlo (MCMC) technique which samples the parameter space with a frequency proportional to the desired posterior p(θ| [symbol] ) can be used to.

The method 400 proceeds from block 416 to block 420, where the computing system can determine a surrogate function (e.g., G(x) in equation (3) above) with an input experiment design as an input. The surrogate function can comprise an expected value (e.g., [symbol] (y) in equation (3) above) of the at least one response variable determined using the input experiment design, a variance (e.g., Var(y) in equation (3) above) of the value of the at least one response variable determined using the input experiment design, and an exploitation-exploration trade-off parameter (e.g., α in equation (3) above).

In some embodiments, the exploitation-exploration trade-off parameter is 0 to 1 (e.g., 0, 0.1, 0.2, 0.3, 0.4, 0.5, 0.6, 0.7, 0.8, 0.9, or 1). The exploitation-exploration trade-off parameter can be close to about 1 if a current cycle and/or the next cycle of the synthetic biology experiment is an early cycle of the synthetic biology experiment. The exploitation-exploration trade-off parameter can be close to about 0 if the current cycle and/or the next cycle of the synthetic biology experiment is a later cycle of the synthetic biology experiment. In some embodiments, the surrogate function comprises no expected value of the at least one response variable when the exploitation-exploration trade-off parameter is 1. For example, for the maximization case for α=1 G(x)=Var(y)^{1/2}, so the method suggests next steps that maximize the response variance, thus exploring parts of the phase space where the model shows high predictive uncertainty. The surrogate function can comprise no variance of the value of the at least one response variable when the exploitation-exploration trade-off parameter is 0. For example, for α=0, G(x)=E(y), the method suggests next steps that maximize the expected response, thus exploiting our model to obtain the best response. In some embodiments, the computing system can determine the exploitation-exploration trade-off parameter based on a current and/or the next cycle of the synthetic biology experiment. The exploitation-exploration trade-off parameter can be predetermined.

The method 400 proceeds from block 420 to block 424, where the computing system can determine, using the surrogate function, a plurality of recommended experiment designs, each comprising recommended values of the input variables, for a next cycle of a synthetic biology experiment for obtaining a predetermined response variable objective associated with the at least one response variable. The next cycle of the synthetic biology experiment can comprise, for example, a 1st cycle, a 2nd cycle, a 3rd cycle, a 4th cycle, a 5th cycle, a 6th cycle, a 7th cycle, a 8th cycle, a 9th cycle, or a 10th cycle, of the synthetic biology experiment.

In some embodiments, the computing system can maximize the surrogate function

$$( e . g . , \begin{matrix}{argmax}_{x} G ( x ) \\ s . t . x ∈ ℬ\end{matrix} above )$$

to determine the plurality of recommended experiment designs. In some embodiments, the computing system can determine a plurality of possible recommended experiment designs each comprising possible recommended values of the input variables with surrogate function values, determined using the surrogate function, with a predetermined characteristic (e.g., highest or lowest). To determine the plurality of possible recommended experiment designs, the computing system can sample (e.g., using Markov Chain Monte Carlo (MCMC)) a space of the input variables with a frequency proportional to the surrogate function, or an exponential function of the surrogate function, and a prior distribution of the input variables. For example, samples can be drawn from a target distribution defined as π(x)∝ exp(G(x))p(x) in equation (4) above. The computing system can sample the space of the input variables at a plurality of temperatures (such as for tempering, such as parallel temperature). For example, parallel tempering can be used for optimization through sampling, in which multiple chains at different temperatures are used for exploration of the target distribution (FIG. 3).

The computing system can select the plurality of recommended experiment designs from the plurality of possible recommended experiment designs using an input variable difference factor (e.g., γ above) based on the surrogate function values of the plurality of possible recommended experiment designs. The recommended value of at least one input variable of each of the plurality of recommended experiment designs can differ from the recommended value of the at least one input variable of every other recommended experiment design of the plurality of recommended experiment designs and the training data by the input variable difference factor. The input variable difference factor can be, or be about, 0.05, 0.1, 0.15, 0.2, 0.3, 0.4, 0.5, or more.

In some embodiments, the computing system can iteratively, for possible recommended experiment designs of the plurality of possible recommended experiment designs in an order of the predetermined characteristics (e.g., from the highest to the lowest), determine a possible recommended value of at least one input variable of a possible recommended experiment design of the plurality of possible recommended experiment designs differs from the recommended value of the at least one input variable of one or more recommended experiment designs of the plurality of recommended experiment designs already selected, if any, and the training data by the input variable difference factor. The computing system can continue iteratively select the possible recommended experiment design of the plurality of possible recommended experiment designs as a recommended experiment design of the plurality of recommended experiment designs. The computing system can determine a number of the possible recommended experiment designs selected is below a desired number of the plurality recommended experiment designs. The computing system can decrease the input variable difference factor. See Algorithm 1 in Example 1 for an example of choosing recommendations from a set of samples from the target distribution π(x).

The desired number of the plurality recommended experiment designs can be, or be about, 2, 5, 10, 15, 20, 30, 40, 50, 100, 200, 300, 400, 500, 1000, 2000, 3000, 4000, 5000, 10000, or more. In some embodiments, the desired number of the plurality of recommended experiment designs is predetermined. In some embodiments, the computing system can determine the desired number of the plurality of recommended experiment designs based on a probability of one, or each, of the possible recommended experiment designs selected achieving the predetermined response variable objective associated with the at least one response variable and/or a probability of at least one of the plurality of possible recommended experiment designs selected achieving the predetermined response variable objective associated with the at least one response variable.

In some embodiments, a number of the plurality of recommended experiment designs corresponds to a number of experimental conditions or a number of strains for the next cycle of the synthetic biology experiment. The plurality of recommended experiment designs can comprise one or more gene drives and/or one or more pathway designs. A number of the plurality of recommended experiment designs can be, or be about, 2, 5, 10, 15, 20, 30, 40, 50, 100, 200, 300, 400, 500, 1000, 2000, 3000, 4000, 5000, 10000, or more.

In some embodiments, the computing system can determine an upper bound and/or a lower bound for one, or each, of the plurality of input variables based on training values of the corresponding input variable (see equation (7) for an example). Each of the possible recommended values of the input variables can be within the upper bound and/or the lower bound of the corresponding input variable. The upper bound of one, or each, of the plurality of input variables can be a predetermined upper bound factor (e.g., E above) higher than a highest training value of the training values of the corresponding input variable. The predetermined upper bound factor can be, or be about, 0.01, 0.02, 0.03, 0.05, 0.1, 0.15, 0.2. The lower bound of one, or each, of the plurality of input variables can be a predetermined lower bound factor (e.g., E above) lower than a lowest training value of the training values of the corresponding input variable. The predetermined lower bound factor can be, or be about, 0.01, 0.02, 0.03, 0.05, 0.1, 0.15, 0.2. In some embodiments, computing system can receive an upper bound and/or a lower bound for one, or each, of the plurality of input variables. Each of the possible recommended values of the input variables can be within the upper bound and/or the lower bound of the corresponding input variable.

In some embodiments, the computing system can determine, using the posterior distribution of the ensemble parameters given the training data or the second subset of the training data, a probability distribution of the at least one response variable (e.g., p(y|x*, [symbol] ) in equation (2) above) for one, or each, of the plurality of recommended experiment designs.

In some embodiments, the computing system can determine, using the posterior distribution of the ensemble parameters given the training data or the second subset of the training data, a probability of one, or each, of the plurality of recommended experiment designs achieving the predetermined response variable objective associated with the at least one response variable (e.g., p( [symbol] |x^{r}) above). The probability of one, or each, of the plurality of recommended experiment designs achieving the predetermined response variable objective associated with the at least one response variable can comprise the probability of one, or each, of the plurality of recommended experiment designs being a predetermined percentage closer to achieving the objective relative to the training data. In some embodiments, the computing system can determine, using the posterior distribution of the ensemble parameters given the training data or the second subset of the training data, a probability of at least one of the plurality of recommended experiment designs achieving the predetermined response variable objective associated with the at least one response variable (e.g., p( [symbol] |{x^{r}}) above). The probability of the at least one of the plurality of recommended experiment designs achieving the predetermined response variable objective associated with the at least one response variable can comprise the probability of the at least one of the plurality of recommended experiment designs achieving the predetermined response variable objective being a predetermined percentage closer to achieving the objective relative to the training data. The predetermined percentage can be, or be about, 1%, 2%, 3%, 4%, 5%, 10%, 15%, 20%, 30%, or more.

The method 400 ends at block 428.

### Determining Experiment Designs

Disclosed herein include methods for recommending experiment designs for biology, such as synthetic biology. In some embodiments, a method for recommending experiment designs for biology is under control of a hardware processor and comprises: receiving a probabilistic predictive model for recommending experiment designs for synthetic biology comprising a plurality of level-0 learners and a level-1 learner. An input of each of the plurality of level-0 learners can comprise input values of the input variables. An output of each of the plurality of level-0 learners can comprise a predicted value of at least one response variable. The level-1 learner can comprise a probabilistic ensemble of the plurality of level-0 learners. An output of the level-1 learner can comprise a predicted probabilistic distribution of the at least one response variable. The plurality of level-0 learners and the level-1 learner can be trained using training data obtained from one or more cycles of a synthetic biology experiment comprising a plurality of training inputs and corresponding reference outputs. Each of the plurality of training inputs can comprise training values of input variables. Each of the plurality of reference outputs can comprise a reference value of at least one response variable associated with a predetermined response variable objective. For example, the plurality of level-0 learners and the level-1 learner can be trained as described with reference to blocks 408, 412, and/or 416 of the method 400. The method can comprise: determining a surrogate function comprising an expected value of the level-1 learner, a variance of the level-1 learner, and an exploitation-exploration trade-off parameter (see block 420 of the method 400 and the accompanying descriptions). The method can comprise: determining, using the surrogate function, a plurality of recommended experiment designs, each comprising recommended values of the input variables, for a next cycle of the synthetic biology experiment for achieving a predetermined response variable objective associated with the at least one response variable (see block 424 of the method 400 and the accompanying descriptions).

In some embodiments, the method comprises: training the plurality of level-0 learners and the level-1 learner using the synthetic biology experimental data. Training the plurality of level-0 learners and the level-1 learner using the synthetic biology experimental data can comprise: training the plurality of level-0 learners and the level-1 learner using the synthetic biology experimental data using any system of the present disclosure. Training the plurality of level-0 learners and the level-1 learner can comprise: generating the training data from synthetic biology experimental data obtained from one or more cycles of a synthetic biology experiment see block 408 of the method 400 and the accompanying descriptions). Training the plurality of level-0 learners and the level-1 learner can comprise: training, using the training data, the plurality of level-0 learners of the probabilistic predictive model for recommending experiment designs for synthetic biology (see block 412 of the method 400 and the accompanying descriptions). Training the plurality of level-0 learners and the level-1 learner can comprise: training, using (i) predicted values of the at least one response variable determined using the plurality of level-0 learners for the training inputs of the plurality of training inputs, and (ii) the reference outputs of the plurality of reference outputs correspondence to the training inputs of the plurality of training inputs, a level-1 learner of the probabilistic predictive model for recommending experiment designs for synthetic biology see block 416 of the method 400 and the accompanying descriptions). The method can comprise: determining, using the probabilistic predictive model, a predicted probability distribution of the response variable for each of the plurality of recommended experiment designs.

### Performing a Biology Experiment

Disclosed herein include methods for performing a biology (e.g., synthetic biology) experiment. In some embodiments, the method comprises: performing one cycle of a synthetic biology experiment to obtain synthetic biology experimental data. The method can comprise: training a probabilistic predictive model for recommending experiment designs for synthetic biology using the synthetic biology experimental data as described herein. See blocks 412 and 416 of the method 400 and accompanying descriptions for examples. The method can comprise determining a plurality of recommended experiment designs using the probabilistic predictive model. See blocks 420 and 424 of the method 400 and the accompanying descriptions for examples. The method can comprise: performing a next cycle of the synthetic biology experiment using the plurality of recommended experiment designs.

In some embodiments, the method comprises, for each cycle of a plurality of cycles of a synthetic biology experiment: performing the cycle of the synthetic biology experiment to obtain synthetic biology experimental data for the cycle. The method can comprise: training a probabilistic predictive model for recommending experiment designs for synthetic biology using the synthetic biology experimental data of the cycle and any prior cycle, if any. See blocks 412 and 416 of the method 400 and accompanying descriptions for examples. The method can comprise: determining a plurality of recommended experiment designs using the probabilistic predictive model. See blocks 420 and 424 of the method 400 and the accompanying descriptions for examples. The method can comprise: performing a next cycle of the synthetic biology experiment using the plurality of recommended experiment designs. The plurality of cycles of the synthetic biology experiment can comprise, or comprise, about, 2 cycles, 3 cycles, 4 cycles, 5 cycles, 6 cycles, 7 cycles, 8 cycles, 9 cycles, 10 cycles, 20 cycles, or more, of the synthetic biology experiment.

### Execution Environment

In FIG. 5 depicts a general architecture of an example computing device 500 configured for training and/or using a probabilistic predictive ensemble model for recommending experiment designs for biology. The general architecture of the computing device 500 depicted in FIG. 5 includes an arrangement of computer hardware and software components. The computing device 500 may include many more (or fewer) elements than those shown in FIG. 5. It is not necessary, however, that all of these generally conventional elements be shown in order to provide an enabling disclosure. As illustrated, the computing device 500 includes a processing unit 510, a network interface 520, a computer readable medium drive 530, an input/output device interface 540, a display 550, and an input device 560, all of which may communicate with one another by way of a communication bus. The network interface 520 may provide connectivity to one or more networks or computing systems. The processing unit 510 may thus receive information and instructions from other computing systems or services via a network. The processing unit 510 may also communicate to and from memory 570 and further provide output information for an optional display 550 via the input/output device interface 540. The input/output device interface 540 may also accept input from the optional input device 560, such as a keyboard, mouse, digital pen, microphone, touch screen, gesture recognition system, voice recognition system, gamepad, accelerometer, gyroscope, or other input device.

The memory 570 may contain computer program instructions (grouped as modules or components in some embodiments) that the processing unit 510 executes in order to implement one or more embodiments. The memory 570 generally includes RAM, ROM and/or other persistent, auxiliary or non-transitory computer-readable media. The memory 570 may store an operating system 572 that provides computer program instructions for use by the processing unit 510 in the general administration and operation of the computing device 500. The memory 570 may further include computer program instructions and other information for implementing aspects of the present disclosure.

For example, in one embodiment, the memory 570 includes a training module 574 for training a probabilistic predictive ensemble model for recommending experiment designs for biology, such as blocks 408, 412, and/or 416 of the method 400 described with reference to FIG. 4. The memory 570 may additionally or alternatively include a recommendation module 576 for using a probabilistic predictive ensemble model for recommending experiment designs for biology, such as blocks 420 and/or 424 of the method 400 described with reference to FIG. 4. In addition, memory 570 may include or communicate with the data store 590 and/or one or more other data stores that stores experimental data for one or more cycles of a biology experiment, training data generated from experimental data for one or more cycles of a biology experiment, one or more probabilistic predictive ensemble models for one or more cycles of a biology experiment, and/or recommended experiment designs for one or more cycles of a biology experiment.

### EXAMPLES

Some aspects of the embodiments discussed above are disclosed in further detail in the following example, which is not in any way intended to limit the scope of the present disclosure.

### Example 1

### ART: A Machine Learning Automated Recommendation Tool for Synthetic Biology

Synthetic biology allows bioengineering of cells to synthesize novel valuable molecules such as renewable biofuels or anticancer drugs. However, traditional synthetic biology approaches involve ad-hoc engineering practices, which lead to long development times. This example presents the Automated Recommendation Tool (ART), a tool that leverages machine learning and probabilistic modeling techniques to guide synthetic biology in a systematic fashion, without necessarily a full mechanistic understanding of the biological system. Using sampling-based optimization, ART provides a set of recommended strains to be built in the next engineering cycle, alongside probabilistic predictions of their production levels. This example demonstrates the capabilities of ART on simulated data sets, as well as experimental data from real metabolic engineering projects producing renewable biofuels, hoppy flavored beer without hops, and fatty acids.

### Introduction

Metabolic engineering enables bioengineering of cells to synthesize novel valuable molecules such as renewable biofuels or anticancer drugs. The prospects of metabolic engineering to have a positive impact in society are on the rise, as metabolic engineering was considered one of the “Top Ten Emerging Technologies” by the World Economic Forum in 2016. Furthermore, an incoming industrialized biology is expected to improve most human activities: from creating renewable bioproducts and materials, to improving crops and enabling new biomedical applications.

However, the practice of metabolic engineering has been far from systematic, which has significantly hindered its overall impact. Metabolic engineering has remained a collection of useful demonstrations rather than a systematic practice based on generalizable methods. This limitation has resulted in very long development times: for example, it took 150 person-years of effort to produce the antimalarial precursor artemisinin by Amyris; and 575 person-years of effort for Dupont to generate propanediol, which is the base for their commercially available Sorona fabric.

Synthetic biology aims to improve genetic and metabolic engineering by applying systematic engineering principles to achieve a previously specified goal. Synthetic biology encompasses, and goes beyond, metabolic engineering: it also involves non-metabolic tasks such as gene drives able to extinguish malaria-bearing mosquitoes or engineering microbiomes to replace fertilizers. This discipline is enjoying an exponential growth, as it heavily benefits from the byproducts of the genomic revolution: high-throughput multi-omics phenotyping, accelerating DNA sequencing and synthesis capabilities, and CRISPR-enabled genetic editing. This exponential growth is reflected in the private investment in the field, which has totaled about $12B in the 2009-2018 period and is rapidly accelerating (about $2B in 2017 to about $4B in 2018).

One of the synthetic biology engineering principles used to improve metabolic engineering is the Design-Build-Test-Learn (DBTL) cycle—a loop used recursively to obtain a design that satisfies the desired specifications (e.g., a particular titer, rate, yield or product). The DBTL cycle's first step is to design (D) a biological system expected to meet the desired outcome. That design is built (B) in the next phase from DNA parts into an appropriate microbial chassis using synthetic biology tools. The next phase involves testing (T) whether the built biological system indeed works as desired in the original design, via a variety of assays: e.g., measurement of production or/and 'omics (transcriptomics, proteomics, metabolomics) data profiling. It is extremely rare that the first design behaves as desired, and further attempts are typically needed to meet the desired specification. The Learn (L) step leverages the data previously generated to inform the next Design step so as to converge to the desired specification faster than through a random search process.

The Learn phase of the DBTL cycle has traditionally been the most weakly supported and developed, despite its critical importance to accelerate the full cycle. The reasons are multiple, although their relative importance is not entirely clear. Arguably, the main drivers of the lack of emphasis on the L phase are: the lack of predictive power for biological systems behavior, the reproducibility problems plaguing biological experiments, and the traditionally moderate emphasis on mathematical training for synthetic biologists.

Machine learning (ML) arises as an effective tool to predict biological system behavior and empower the Learn phase, enabled by emerging high-throughput phenotyping technologies. Machine learning has been used to produce driverless cars, automate language translation, predict sensitive personal attributes from Facebook profiles, predict pathway dynamics, optimize pathways through translational control, diagnose skin cancer, detect tumors in breast tissues, predict DNA and RNA protein-binding sequences, drug side effects and antibiotic mechanisms of action. However, the practice of machine learning requires statistical and mathematical expertise that is scarce and highly competed for in other fields.

This example provides a tool that leverages machine learning for synthetic biology's purposes: the Automated Recommendation Tool (ART). In this example, ART combines the general-purpose open source scikit-learn library with a novel Bayesian ensemble approach, in a manner that adapts to the particular needs of synthetic biology projects: e.g., low number of training instances, recursive DBTL cycles, and the need for uncertainty quantification. The data sets collected in the synthetic biology field are typically not large enough to allow for the use of deep learning (e.g., 100 instances), but the ensemble model of the example can process large data sets from high-throughput data generation and automated data collection when available. ART provides machine learning capabilities in an easy-to-use and intuitive manner, and is able to guide synthetic biology efforts in an effective way.

The example showcases the efficacy of ART in guiding synthetic biology by mapping-omics data to production through four different examples: one test case with simulated data and three real cases of metabolic engineering. In all these cases the -omics data (proteomics in these examples, but it could be any other type: transcriptomics, metabolomics, etc.) were assumed to be predictive of the final production (response), and that there is enough control over the system so as to produce any new recommended input. The test case permits exploring how the algorithm performs when applied to systems that present different levels of difficulty when being “learnt”, as well as the effectiveness of using several DTBL cycles. The real metabolic engineering cases involve data sets from published metabolic engineering projects: renewable biofuel production, yeast bioengineering to recreate the flavor of hops in beer, and fatty alcohols synthesis. These projects illustrate what to expect under different typical metabolic engineering situations: high/low coupling of the heterologous pathway to host metabolism, complex/simple pathways, high/low number of conditions, high/low difficulty in learning pathway behavior. ART's ensemble approach can successfully guide the bioengineering process even in the absence of quantitatively accurate predictions. Furthermore, ART's ability to quantify uncertainty is crucial to gauge the reliability of predictions and effectively guide recommendations towards the least known part of the phase space. These experimental metabolic engineering cases also illustrate how applicable the underlying assumptions are, and what happens when the assumptions may not hold true.

In sum, ART can be a tool specifically tailored to the synthetic biologist's needs in order to leverage the power of machine learning to enable predictable biology. This combination of synthetic biology with machine learning and automation has the potential to revolutionize bioengineering by enabling effective inverse design.

### Methods

### Capabilities

ART leverages machine learning to improve the efficacy of bioengineering microbial strains for the production of desired bioproducts (FIG. 1). ART can get trained on available data to produce a model capable of predicting the response variable (e.g., production of the jet fuel limonene) from the input data (e.g., proteomics data, or any other type of data that can be expressed as a vector). Furthermore, ART uses this model to recommend new inputs (e.g., proteomics profiles) that are predicted to reach our desired goal (e.g., improve production). As such, ART can bridge the Learn and Design phases of a DBTL cycle.

FIG. 1. ART predicts the response from the input and provides recommendations for the next cycle. ART can use experimental data to i) build a probabilistic predictive model that predicts response (e.g., production) from input variables (e.g., proteomics), and ii) uses this model to provide a set of recommended designs for the next experiment, along with the probabilistic predictions of the response.

ART can import data directly from Experimental Data Depot (EDD), an online tool where experimental data and metadata are stored in a standardized manner. Alternatively, ART can import EDD-style .csv files, which use the nomenclature and structure of EDD exported files.

By training on the provided data set, ART builds a predictive model for the response as a function of the input variables. Rather than predicting point estimates of the output variable, ART can provide the full probability distribution of the predictions. This rigorous quantification of uncertainty enables a principled way to test hypothetical scenarios in-silico, and to guide design of experiments in the next DBTL cycle. The Bayesian framework used to provide the uncertainty quantification is particularly tailored to the type of problems most often encountered in metabolic engineering: sparse data which is expensive and time consuming to generate.

With a predictive model at hand, ART can provide a set of recommendations expected to produce a desired outcome, as well as probabilistic predictions of the associated response. ART can support the following typical metabolic engineering objectives: maximization of the production of a target molecule (e.g., to increase Titer, Rate, and Yield (TRY)), its minimization (e.g., to decrease the toxicity), as well as specification objectives (e.g., to reach specific level of a target molecule for a desired beer taste profile). Furthermore, ART leverages the probabilistic model to estimate the probability that at least one of the provided recommendations is successful (e.g., ART improves the best production obtained so far), and derives how many strain constructions would be required for a reasonable chance to achieve the desired goal.

ART can be applied to problems with multiple output variables of interest. In some embodiments, the multiple output variables can have the same type of objective for all output variables. In some embodiments, the multiple output variables can have different types of objectives for the output variables. For example, ART can support maximization of one target molecule along with minimization of another (see the “Success probability calculation” section).

### Mathematical Methodology

Learning from Data: A Predictive Model Through Machine Learning and a Bayesian Ensemble Approach

By learning the underlying regularities in experimental data, ART can provide predictions without necessarily a detailed mechanistic understanding (FIG. 2). Training data can be used to statistically link an input (features or independent variables) to an output (response or dependent variables) through models that are expressive enough to represent almost any relationship. After this training, the models can be used to predict the outputs for inputs that the model has never seen before.

FIG. 2. ART provides a probabilistic predictive model of the response (e.g., production). ART combines several machine learning (ML) models (e.g., from the scikit-learn library in this example) with a novel Bayesian approach to predict the probability distribution of the output. The input to ART can be proteomics data (or any other input data in vector format: transcriptomics, gene copy, etc.), referred to herein as level-0 data. This level-0 data can be used as input for a variety of machine learning models (level-0 learners) that produce a prediction of production for each model (z₁). These predictions (level-1 data) can be used as input for the Bayesian ensemble model (level-1 learner), which weighs these predictions (or the level-0 learners that produce the predictions) differently depending on each level-0 learner's ability to predict the training data. The weights wᵢ and the variance a can be characterized through probability distributions, giving rise to a final prediction in the form of a full probability distribution of response levels.

Model selection is a significant challenge in machine learning, since there is a large variety of models available for learning the relationship between response and input, but none of them is optimal for all learning tasks. Furthermore, each model features hyperparameters (parameters that are set before the training process) that crucially affect the quality of the predictions (e.g., number of trees for random forest or degree of polynomials in polynomial regression), and finding their optimal values is not trivial.

ART can sidestep the challenge of model selection by using an ensemble model approach. This approach takes the input of various different models and has them “vote” for a particular prediction. Each of the ensemble members is trained to perform the same task, and their predictions are combined to achieve an improved performance. The examples of the random forest or the super learner algorithm have shown that simple models can be significantly improved by using a set of them (e.g., several types of decision trees in a random forest algorithm). An ensemble model can either use a set of different models (heterogeneous case) or the same models with different parameters (homogeneous case). ART can be based on a heterogeneous ensemble learning approach that uses reasonable hyperparameters for each of the model types, rather than specifically tuning hyperparameters for each of them.

ART uses a novel probabilistic ensemble approach where the weight of each ensemble model is considered a random variable, with a probability distribution inferred by the available data. Unlike other approaches, this method does not require the individual models to be probabilistic in nature, hence allowing fully exploiting the popular scikit-learn library to increase accuracy by leveraging a diverse set of models (see the “Comparisons”). The weighted ensemble model approach produces a simple, yet powerful, way to quantify both epistemic and aleatoric uncertainty—a critical capability when dealing with small data sets and a crucial component of AI in biological research. The ensemble approach can be used for the single response variable problems. Alternatively or additionally, the ensemble approach can be used for the multiple variables case, described in further details in the “Multiple response variables” section. Using a common notation in ensemble modeling, the following levels of data and learners (see FIG. 2) can be defined.

Level-0 data ( [symbol] ) represent the historical data including N known instances of inputs and responses, that is [symbol] ={(xₙ, yₙ), n=1, . . . , N}, where x∈ [symbol] ⊆ [symbol] ^{D} is the input comprised of D features and y∈ [symbol] is the associated response variable. For the sake of cross-validation, the level-0 data are further divided into validation ( [symbol] ^{(k)}) and training sets ( [symbol] ^{(-k)}). [symbol] ^{(k)}⊂ [symbol] is the kth fold of a K-fold cross-validation obtained by randomly splitting the set [symbol] into K almost equal parts, and [symbol] ^{(-k)}= [symbol] \ [symbol] ^{(k)} is the set [symbol] without the kth fold [symbol] ^{(k)}. Note that these sets do not overlap and cover the full available data; that is [symbol] ^{(k}^{ᵢ}⁾∩ [symbol] ^{(k}^{ⱼ}⁾=ø, i≠j and ∪Uᵢ [symbol] ^{(k}^{ᵢ}⁾= [symbol] .

Level-0 learners (fₘ) includes M base learning algorithms fₘ, m=1, . . . , M used to learn from level-0 training data [symbol] ^{(-k)}. For ART in this example, the following eight algorithms from the scikit-learn library were used: random forest, neural network, support vector regressor, kernel ridge regressor, K-NN regressor, Gaussian process regressor, gradient boosting regressor, as well as TPOT (tree-based pipeline optimization tool). TPOT uses genetic algorithms to find the combination of the 11 different regressors and 18 different preprocessing algorithms from scikit-learn that, properly tuned, can provide the best achieved cross-validated performance on the training set.

Level-1 data ( [symbol] _{cv}) are data derived from [symbol] by leveraging cross-validated predictions of the level-0 learners. More specifically, level-1 data can be the set [symbol] _{cv}={(zₙ, yₙ), n=1, . . . , N}, where zₙ=(z₁ₙ . . . , z_{Mn}) are predictions for level-0 data (xₙ∈ [symbol] ^{(k)}) of level-0 learners (fₘ^{(-k)}) trained on observations which are not in fold k ( [symbol] ^{(-k)}, that is zₘₙ=fₘ^{(-k)}(xₙ), m=1, . . . , M.

Level-1 learner (F), or metalearner, is a linear weighted combination of level-0 learners, with weights wₘ, m=1, . . . , M being random variables that are non-negative and normalized to one. Each wₘ can be interpreted as the relative confidence in model m. More specifically, given an input x the response variable y is modeled as:

F:y=w^{T}f(x)+ε,ε˜ [symbol] (0,σ²), (1)

where w=[w₁ . . . w_{M}]^{T} is the vector of weights such that Σwₘ=1, wₘ≥0, f(x)=[f₁(x) . . . f_{M}(x)]^{T} is the vector of level-0 learners, and ε is a normally distributed error variable with a zero mean and standard deviation σ. The constraint Σwₘ=1 (that the ensemble is a convex combination of the base learners) is empirically motivated but also supported by theoretical considerations. The unknown ensemble model parameters can be denoted as θ≡(w,σ), constituted of the vector of weights and the Gaussian error standard deviation. The parameters θ are obtained by training F on the level-1 data [symbol] _{cv}. However, the final model F to be used for generating predictions for new inputs uses these θ, inferred from level-1 data [symbol] _{cv}, and the base learners fₘ, m=1, . . . , M trained on the full original data set [symbol] , rather than only on the level-0 data partitions [symbol] ^{(-k)}.

Rather than providing a single point estimate of ensemble model parameters θ that best fit the training data, a Bayesian model provides a joint probability distribution which quantifies the probability that a given set of parameters explains the training data. This Bayesian approach makes possible to not only make predictions for new inputs but also examine the uncertainty in the model. Model parameters θ are characterized by full posterior distribution p(θ| [symbol] ) that is inferred from level-1 data. Since this distribution is analytically intractable, ART can sample from the distribution using the Markov Chain Monte Carlo (MCMC) technique, which samples the parameter space with a frequency proportional to the desired posterior p(θ| [symbol] ) (See the “Markov Chain Monte Carlo sampling” section).

As a result, instead of obtaining a single value as the prediction for the response variable, the ensemble model produces a full distribution that takes into account the uncertainty in model parameters. For a new input x* (not present in [symbol] ), the ensemble model F provides the probability that the response is y, when trained with data [symbol] (the full predictive posterior distribution):

p(y|x*, [symbol] )=∫p(y|x*,θ)p(θ| [symbol] )dθ=∫ [symbol] (y;w^{T}f,σ²)p(θ| [symbol] )dθ, (2)

where p(y|x*, θ) is the predictive distribution of y given input x* and model parameters θ, p(θ| [symbol] ) is the posterior distribution of model parameters given data [symbol] , and f≡f(x*) for the sake of clarity.

Optimization: Suggesting Next Steps

The optimization phase leverages the predictive model described in the previous section to find inputs with corresponding outputs that are predicted to be closer to the objective (e.g., maximize or minimize response, or achieve a desired response level). In mathematical terms, the optimization phase is looking for a set of Nᵣ suggested inputs xᵣ∈ [symbol] ; r=1, . . . , Nᵣ, that optimize the response with respect to the desired objective. Specifically, a process with the following characteristics is desired:

i) optimizing the predicted levels of the response variable;

ii) being able to explore the regions of input phase space associated with high uncertainty in predicting response, if desired; and

iii) providing a set of different recommendations, rather than only one.

In order to meet these three requirements, the optimization problem is defined formally as

$$\begin{matrix}{argmax}_{x} G ( x ) \\ s . t . x ∈ ℬ\end{matrix} ,$$

where the surrogate function G(x) is defined as:

$$G ( x ) = \{ \begin{matrix}( 1 - α ) 𝔼 ( y ) + α {Var ( y )}^{1 / 2} & ( maximization case ) \\ - ( 1 - α ) 𝔼 ( y ) + α {Var ( y )}^{1 / 2} & ( minimization case ) \\ - ( 1 - α ) {‖ 𝔼 ( y ) - {y}^{*} ‖}_{2}^{2} + α {Var ( y )}^{1 / 2} & ( specification case )\end{matrix} , \qquad ( 3 )$$

depending on which mode ART is operating in (see “Key capabilities” section). Here, y* is the target value for the response variable, y=y(x), [symbol] (y) and Var(y) denote the expected value and variance respectively (see the “Expected value and variance for ensemble model” section), ∥x∥₂²=Σᵢxᵢ² denotes Euclidean distance, and the parameter α∈[0,1] represents the exploitation-exploration trade-off (see below). The constraint such that (s.t.) x∈ [symbol] for

$${argmax}_{x} G ( x )$$

characterizes the lower and upper bounds for each input feature (e.g., protein levels cannot increase beyond a given, physical, limit). These bounds can be provided by a user (see details in the “Implementation” section); otherwise default values are computed from the input data as described in the “Input space set [symbol] ” section.

Requirements i) and ii) can be both addressed using Bayesian optimization: optimization of a parametrized surrogate function which accounts for both exploitation and exploration. The objective function G(x) takes the form of the upper confidence bound given in terms of a weighted sum of the expected value and the variance of the response (parametrized by α, Eq. 3). This scheme accounts for both exploitation and exploration: for the maximization case, for example, for α=1 G(x)=Var(y)^{1/2}, so the algorithm suggests next steps that maximize the response variance, thus exploring parts of the phase space where the model shows high predictive uncertainty. For α=0, G(x)=E(y), and the algorithm suggests next steps that maximize the expected response, thus exploiting our model to obtain the best response. Intermediate values of a produce a mix of both behaviors. α can be set to values slightly smaller than 1 (e.g., 0.9) for early-stage DBTL cycles, thus allowing for more systematic exploration of the space so as to build a more accurate predictive model in the subsequent DBTL cycles. If the objective is purely to optimize the response, α can be set to 0.

In order to address (iii), as well as to avoid entrapment in local optima and search the phase space more effectively, the optimization problem can be solved through sampling. More specifically, samples can be drawn from a target distribution defined as

π(x)∝ exp(G(x))p(x), (4)

where p(x)= [symbol] ( [symbol] ) can be interpreted as the uniform ‘prior’ on the set [symbol] , and exp(G(x)) as the ‘likelihood’ term of the target distribution. Sampling from π implies optimization of the function G(but not reversely), since the modes of the distribution π correspond to the optima of G. MCMC can be used for sampling. The target distribution is not necessarily differentiable and may well be complex. For example, if it displays more than one mode, as is often the case in practice, there is a possibility that a Markov chain gets trapped in one of them. In order to make the chain explore all areas of high probability one can “flatten/melt down” the roughness of the distribution by tempering. For this purpose, the Parallel Tempering algorithm can be used for optimization of the objective function through sampling, in which multiple chains at different temperatures are used for exploration of the target distribution (FIG. 3).

FIG. 3. ART chooses recommendations for next steps by sampling the modes of a surrogate function. The leftmost panel shows the true response y (e.g., biofuel production to be optimized) as a function of the input x (e.g., proteomics data), as well as the expected response E(y) after several DBTL cycles, and its 95% confidence interval (blue). The objective can be to explore the phase space where the model is least accurate or to exploit the predictive model to obtain the highest possible predicted responses. Depending on the objective, a surrogate function G(x) (Eq. 3), where the exploitation-exploration parameter is α=0 (pure exploitation), α=1 (pure exploration) or anything in between, can be optimized. Parallel-Tempering-based MCMC sampling (center and right side) produces sets of vectors x (colored dots) for different “temperatures”: higher temperatures (red) explore the full phase space, while lower temperature chains (blue) concentrate in the nodes (optima) of G(x). Exchange between different “temperatures” provides more efficient sampling without getting trapped in local optima. Final recommendations (blue arrows) to improve response are provided from the lowest temperature chain, and chosen such that the final recommendations are not too close to each other and to experimental data (e.g., at least 20% difference).

Choosing Recommendations for the Next Cycle

After drawing a certain number of samples from π(x), recommendations for the next cycle are chosen. The chosen recommendations can be sufficiently different from each other as well as from the input experimental data. To do so, first ART can find a sample with optimal G(x) (note that G(x) values are already calculated and stored). This sample can be accepted as a recommendation if there is at least one feature whose value is different by at least a factor γ (e.g., 20% difference, γ=0.2) from the values of that feature in all data points x∈ [symbol] . Otherwise, for the next optimal sample, check the same condition. This procedure is repeated until the desired number of recommendations are collected, and the condition involving γ is satisfied for all previously collected recommendations and all data points. In case all draws are exhausted without collecting the sufficient number of recommendations, ART can decrease the factor γ and repeat the procedure from the beginning. Pseudo code for this algorithm can be found in Algorithm 1 in the “Implementation” section. The probability of success for these recommendations is computed as indicated in the “Success probability calculation” section.

Markov Chain Monte Carlo Sampling

The posterior distribution p(θ| [symbol] ) (probability that the parameters θ fit the data [symbol] , used in Eq. 2) is obtained by applying Bayes' formula with the posterior distribution being defined through a prior p(θ) and a likelihood function p( [symbol] |θ) as

p(θ| [symbol] )∝p( [symbol] |θ)p(θ).

The prior can be defined to be p(θ)=p(w)p(σ), where p(w) is a Dirichlet distribution with uniform parameters, which ensures the constraint on weights (the weights add to one) is satisfied, and p(σ) is a half normal distribution with mean and standard deviation set to 0 and 10, respectively. The likelihood function follows directly from Eq. 1 as

$$p ( 𝒟 \vert θ ) = {\prod }_{n = 1}^{N} p ( {y}_{n} \vert {x}_{n} , θ ) , \\ p ( {y}_{n} \vert {x}_{n} , θ ) = \frac{1}{σ \sqrt{2 π}} exp \{ - \frac{{( {y}_{n} - {w}^{T} f ( {x}_{n} ) )}^{2}}{2 {σ}^{2}} \} .$$

Expected Value and Variance for Ensemble Model

From Eq. 1, the following can be computed: the expected value

[symbol]

(y)= [symbol] (w^{T}f+ε)= [symbol] (W)^{T}f (5)

and variance

Var(y)=f^{T}Var(w)f+Var(ε) (6)

of the response, which can be used in the optimization phase in order to create the surrogate function G(x) (Eq. 3). The expected value and variance of w and ε can be estimated through sample mean and variance using samples from the posterior distribution p(θ| [symbol] ).

Please note that although p(y|x*, θ) can be modeled to be Gaussian (Eq. 1), the predictive posterior distribution p(y|x*, [symbol] ) (Eq. 2) is not Gaussian due to the complexity of p(θ| [symbol] ) arising from the data and other constraints.

It is important to note that the modeling approach provides quantification of both epistemic and aleatoric uncertainty, through the first and second terms in Eq. 6, respectively. Epistemic (systematic) uncertainty accounts for uncertainty in the model, and aleatoric (statistical) uncertainty describes the amount of noise inherent in the data. While epistemic uncertainty can be eventually explained away given enough data, epistemic uncertainty can be modeled accurately to properly capture situations not encountered in the training set. Modeling epistemic uncertainty is therefore important for small data problems, while aleatoric uncertainty is more relevant for large data problems. In general, it is useful to characterize the uncertainties within a model, as this enables understanding which uncertainties have the potential of being reduced.

Input Space Set

[symbol]

The bounds for the input space [symbol] for G(x) (Eq. 3) can be provided by the user (see details in the Implementation section, Table 3). Otherwise, default values are computed from the input data defining the feasible space as:

$$ℬ = \{ \tilde{x} ∈ {ℝ}^{D} \vert {L}_{d} - {Δ}_{d} \leq {\tilde{x}}^{d} \leq {U}_{d} + {Δ}_{d} , d = 1 , … , D \} \\ {Δ}_{d} = ( {U}_{d} - {L}_{d} ) ϵ ; {U}_{d} = {m}_{1 \leq n \leq N} ( {x}_{n}^{d} ) ; {L}_{d} = {m}_{1 \leq n \leq N} ( {x}_{n}^{d} ) . \\ ( {x}_{n} , {y}_{n} ) ∈ 𝒟 , n = 1 , … , N \qquad ( 7 )$$

The restriction of input variables to the set [symbol] reflects the assumption that the predictive models performs accurately enough only on an interval that is enlarged by a factor ϵ around the minimum and maximum values in the data set (E=0.05 in all calculations).

Success Probability Calculation

The probabilistic model enables estimating the probability of success for the provided recommendations. Of practical interest are the probability that a single recommendation is successful and the probability that at least one recommendation of several provided is successful.

Success is defined differently for each of the three cases considered in Eq. 3: maximization, minimization, and specification. For maximization, success involves obtaining a response y higher than the success value y* defined by the user (e.g., the best production so far improved by a factor of 20%). For minimization, success involves obtaining a response lower than the success value y*. For the specification case, success involves obtaining a response that is as close as possible to the success value y*.

$$𝒮$$

Formally, success for response y is defined through the set [symbol] ={y|y˜ [symbol] (y)}, where the probability distribution for success is

$${p}_{𝒮} ( y ) = \{ \begin{matrix}𝒰 ( {y}^{*} , U ) & ( maximization case ) \\ 𝒰 ( L , {y}^{*} ) & ( minimization case ) \\ 𝒩 ( {y}^{*} , {σ}_{{y}^{*}}^{2} ) & ( specification case )\end{matrix} , \qquad ( 8 )$$

where [symbol] is the uniform distribution ( [symbol] (a, b)=1/(b−a) if a<y<b; 0 otherwise), L and U are its corresponding lower and upper bounds, and σ_{y*}² is the variance of the normal distribution [symbol] around the target value y* for the specification case.

The probability that a recommendation succeeds is given by integrating the probability that input x^{r} gives a response y (full predictive posterior distribution from Eq. 2), times the probability that response y is a success

p( [symbol] |x^{r})= [symbol] (y)p(y|x^{r}, [symbol] )d_{y}.

This success probability is approximated using draws from the posterior predictive distribution as

$$p ( S \vert {x}^{r} ) \approx \{ \begin{matrix}\frac{1}{{N}_{s}} {\sum }_{i = 1}^{{N}_{s}} {𝕀}_{𝒮} ( {y}_{i} ) & ( \frac{maximization}{minimization case} ) \\ \frac{1}{{N}_{s}} {\sum }_{i = 1}^{{N}_{s}} 𝒩 ( {y}_{i} ; {y}^{*} , {σ}_{{y}^{*}}^{2} ) & ( specification case )\end{matrix} , \\ where {y}_{i} \sim p ( y \vert {x}^{r} , 𝒟 ) , i = 1 , … , {N}_{s} , \\ and {𝕀}_{𝒜} ( y ) = 1 if y ∈ 𝒜 , 0 if y ∉ 𝒜 . \qquad ( 9 )$$

In case of multiple recommendations {x^{r}}≡{x^{r}}ᵣ₌₁^{N}^{ᵣ}, ART can provide the probability of success for at least one of the recommendations only for maximization and minimization types of objectives. This probability is calculated as one minus the probability p( [symbol] |{x^{r}}) that all recommendations fail, where

$$p ( ℱ \vert \{ {x}^{r} \} ) \approx \frac{1}{{N}_{s}} {\sum }_{i = 1}^{{N}_{s}} {𝕀}_{ℱ} ( \{ {y}_{i}^{r} \} ) , \\ \{ {y}_{i}^{r} \} ∼ p ( y \vert \{ {x}^{r} \} , 𝒟 ) , i = 1 , … , {N}_{s} , r = 1 , … , {N}_{r} ,$$

and the failure set [symbol] ={{y^{r}}|y^{r}∉ [symbol] , ∀r=1, . . . , Nᵣ} includes outcomes that are not successes for all of the recommendations. Since the chosen recommendations are not necessarily independent, ART samples {yᵢ^{r}} jointly for all {x^{r}}, that is i-th sample has the same model parameters (wᵢ, σᵢ, εᵢⱼ˜ [symbol] (0, σᵢ²) from Eq. 1) for all recommendations.

Multiple Response Variables

For multiple response variable problems (e.g., trying to hit a predetermined value of metabolite a and metabolite b simultaneously, as in the case of the hopless beer), the response variables can be conditionally independent given input vector x, and ART can build a separate predictive model pⱼ(yⱼ|x, [symbol] ) for each variable yⱼ, j=1, . . . , J. The objective function for the optimization phase can be defined as

G(x)=(1−α)Σⱼ₌₁^{J} [symbol] (yⱼ)+αΣⱼ₌₁^{J} Var(yⱼ)^{1/2}

in case of maximization, and analogously adding the summation of expectation and variance terms in the corresponding functions for minimization and specification objectives (Eq. 3). The probability of success for multiple variables is then defined as

p( [symbol] ₁, . . . , [symbol] ⱼ|x)=Πⱼ₌₁^{J}p( [symbol] ⱼ|x^{r})

In some embodiments, correlations among multiple response variables can exist.

Comparisons

The ensemble approach of ART is based on stacking—a method where different ensemble members are trained on the same training set and whose outputs are then combined, as opposed to techniques that manipulate the training set (e.g., bagging) or those that sequentially add new models into the ensemble (e.g., boosting). Different approaches for constructing ensemble of models using the Bayesian framework have been considered. For example, Bayesian Model Averaging (BMA) builds an ensemble model as a linear combination of the individual members in which the weights are given by the posterior probabilities of models. The weights therefore crucially depend on marginal likelihood under each model, which is challenging to compute. BMA accounts for uncertainty about which model is correct but assumes that only one of them is, and as a consequence, it has the tendency of selecting the one model that is the closest to the generating distribution. Agnostic Bayesian learning of ensembles differs from BMA in the way the weights are calculated. Instead of finding the best predictor from the model class (assuming that the observed data is generated by one of them), this method aims to find the best predictor in terms of the lowest expected loss. The weights are calculated as posterior probability that each model is the one with the lowest loss. Bayesian model combination (BMC) seeks the combination of models that is closest to the generating distribution by heavily weighting the most probable combination of models, instead of doing so for the most probable one. BMC samples from the space of possible ensembles by randomly drawing weights from a Dirichlet distribution with uniform parameters. The Bayesian Additive Regression Trees (BART) method is one of the homogeneous ensemble approaches. It models the ensemble as a (non-weighted) sum of regression trees whose parameters, and ensemble error standard deviation, are defined thought their posterior distributions given data and sampled using MCMC suggest a predictive model in terms of a weighted combination of predictive distributions for each probabilistic model in the ensemble. This approach can be seen as a generalization of stacking for point estimation to predictive distributions.

All of these models, except of BMC and the ensemble model of ART, have weights being point estimates, obtained usually by minimizing some error function. In contrast, the weights in ART are random variables, and in contrast to BMC, the weights in ART are defined through full joint posterior distribution given data. BMC is formulated only in the context of classifiers. BART includes a random error term in the ensemble. Unlike BMA, BMC or other models, ART approach does not require that the predictors are themselves probabilistic, and therefore can readily leverage various models such as the scikit-learn models in this example. The main differences are summarized in Table 1.

TABLE 1
Feature differences between Bayesian based ensemble modeling approaches.

| | Weighted | Probabilistic | Probabilistic | | | Ensemble |
|---|---|---|---|---|---|---|
| Method | average | base models | weights | Regression | Classification | error term |
| BMA | ✓ | ✓ | X | ✓ | ✓ | X |
| BMC | ✓ | ✓ | ✓X | X | ✓ | X |
| BART | X | ✓ | X | ✓ | X | ✓ |
| Stacking | ✓ | ✓ | X | ✓ | ✓ | X |
| predictive | | | | | | |
| distributions | | | | | | |
| Agnostic | ✓ | ✓X | X | ✓ | ✓ | X |
| Bayes | | | | | | |
| ART | ✓ | X | ✓ | ✓ | X | ✓ |

Compared to other approaches, the metalearner in ART is modeled as a Bayesian linear regression model, whose parameters are inferred from data combined with a prior that satisfies the constraints on the ‘voting’ nature of ensemble learners.

### Implementation

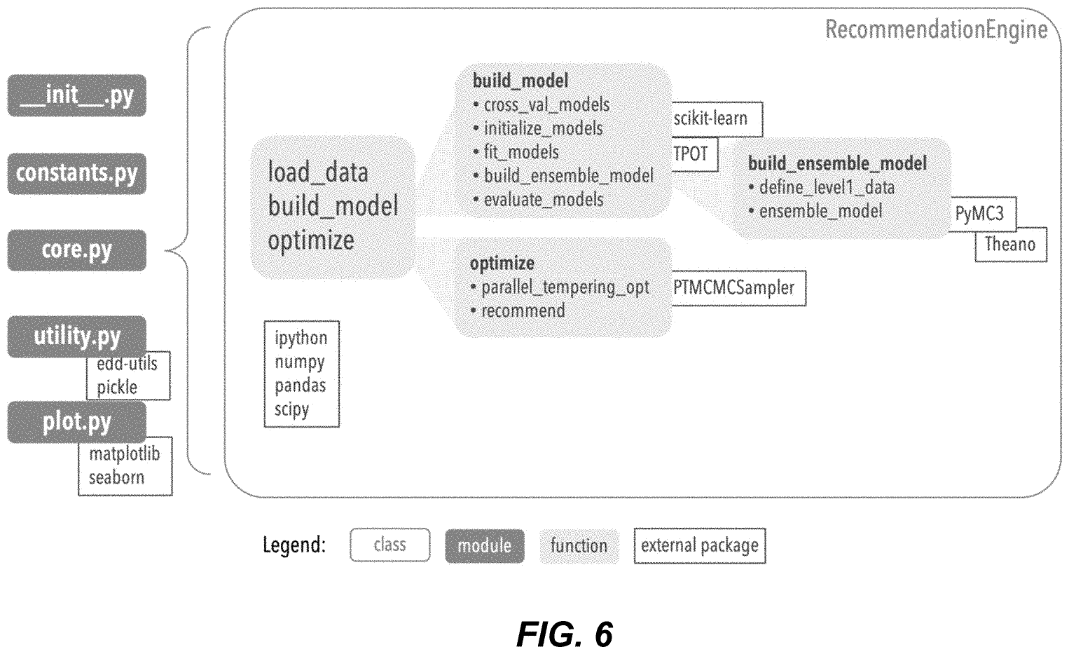

ART in this example was implemented Python 3.6 in this example. See github.com/JBEI/ART for the ART software (the content of which is incorporated herein by reference in its entirety). FIG. 6 represents the main code structure and its dependencies to external packages. An explanation for the main modules and their functions are provided below.

### Modules

core.py is the core module that defines the class RecommendationEngine with functions for loading data (into the format required for machine learning models), building predictive models and optimization (FIG. 6).

The module constants.py contains assignments to all constants appearing throughout all other modules. Those include default values for some of the optional user input parameters (Table 3), hyperparameters for models (scikit-learn models) and simulation setups for PyMC3 and PTMCMCSampler functions.

Module utilities.py is a suite of functions that facilitate ART's computations but can be used independently. It includes functions for loading studies (using EDD through edd-utils or directly from files), metrics for evaluation of predictive models, identifying and filtering noisy data, etc.

Module plot.py contains a set of functions for visualization of different quantities obtained during an ART run, including functions of relevance to final users (e.g., true vs. predicted values) as well as those providing insights into intermediate steps (e.g., predictive models surfaces, space exploration from optimization, recommendations distributions).

All modules can be easily further extended.

### Importing a Study

Studies can be loaded directly from EDD by calling a function from the utility.py module that relies on edd-utils package:

dataframe=load_study(edd_study_slug=edd_study_slug,edd_server=edd_server)

The user should provide the study slug (last part of the study web address) and the url to the EDD server. Alternatively, a study can be loaded from an EDD-style .csv file, by providing a path to the file and calling the same function:

dataframe=load_study(data_file=data_file)

The .csv file should have the same format as an export file from EDD, e.g., the .csv file should contain at least Line Name column, Measurement Type column with names of input and response variables, and Value column with numerical values for all variables.

Either approach will return a pandas dataframe containing all information in the study, which can be pre-processed before running ART, if needed.

### Running ART

ART can be run by instantiating an object from the RecommendationEngine class by:

art=RecommendationEngine(dataframe,**art_params)

The first argument is the dataframe created in the previous step (from an EDD study or data file import). If there is no data preprocessing, the dataframe is ready to be passed as an argument. Otherwise, the user should make sure that the dataframe contains at least the required columns: Line Name, Measurement Type and Value. Furthermore, line names should always contain a hyphen (“-”) denoting replicates (see Table 2), and this character should be exclusively used for this purpose (this point is critical for creating partitions for cross-validation).

TABLE 2
Valid and non-valid examples of entries of the Line Name
column in the dataframe passed to start an ART run.

| ✓ Valid | X Non valid |
|---|---|
| LineNameX-1 | LineNameX1 |
| LineNameX-2 | LineNameX2 |
| LineNameX-r1 | Line-NameX1 |
| LineNameX-r2 | Line-NameX2 |
| LineNameX-R1 | Line-Name-X1 |
| LineNameX-R2 | Line-Name-X2 |
| . . . | . . . |

The second argument is a dictionary of key-value pairs defining several required and optional keyword arguments (summarized in Table 3) for generation of an art object.

TABLE 3
ART input parameters. Required parameters are marked with an asterisk.

| Name | Meaning |
|---|---|
| input_var | List of input variables* |
| bounds_file | Path to the file with upper and lower bounds for each input variable |
| | (default None) |
| response_var | List of response variables* |
| build_model | Flag for building a predictive model (default True) |
| cross_val | Flag for performing cross-validation (default False) |
| ensemble_model | Type of the ensemble model (default ‘BW’) |
| num_models | Number of level-0 models (default 8) |
| recommend | Flag for performing optimization and providing recommendations |
| | (default True) |
| objective | Type of the objective (default ‘maximize’) |
| threshold | Relative threshold for defining success (default 0) |
| target_value | Target value for the specification objective (default None) |
| num_recommendations | Number of recommendations for the next cycle (default 16) |
| rel_eng_accuracy | Relative engineering accuracy or required relative distance between |
| | recommendations (default 0.2) |
| niter | Number of iterations to use for T = 1 chain in parallel tempering |
| | (default 100000) |
| alpha | Parameter determining the level of exploration during the optimization |
| | (value between 0 and 1, default None corresponding to 0) |
| output_directory | Path of the output directory with results (default |
| | . . ./results/response_var_time_suffix) |
| verbose | Amount of information displayed (default 0) |
| seed | Random seed for reproducible runs (default None) |

Building the Model

The level-0 models are first initialized and then fitted through the _initialize_models and _fit_models functions respectively, which rely on the scikit-learn and tpot packages in this example. To build the final predictive model, first the level-1 data is created by storing cross-validated predictions of level-0 models into a theano variable that is shared across the functions from the PyMC3 package. Finally, the parameters of the ensemble model are sampled within the function _ensemble_model, which stores the inferred model and traces that are later used for predictive posterior probability calculation, as well as first and second moments from the traces, used for estimation of the first two moments of the predictive posterior distribution using Eq. 5-6.

By default, ART builds the models using all available data and evaluates the final, ensemble model, as well as all level-0 models, on the same data. Optionally, if specified by the user through the input flag cross_val, ART will evaluate the models on 10-fold cross-validated predictions, through the function _cross_val_models. This computation lasts roughly 10 times longer. Evaluating models on new data, unseen by the models, can also be done by calling:

art.evaluate_models(X=X_new,γ=y_new)

Optimization

ART performs optimization by first creating a set of draws from

draws=art.parallel_tempering_opt( )

which relies on the PTMCMCSampler package. Here, an object from the class TargetModel is created. This class provides a template for and can be replaced by other types of objective functions (or target distributions) for parallel tempering type of optimization, as long as it contains functions defining loglikelihood and log prior calculation (see Eq. 4). Also, the whole optimization procedure may well be replaced by an alternative routine. For example, if the dimension of the input space is relatively small, a grid search could be performed, or even evaluation of the objective at each point for discrete variables. Lastly, out of all draws collected by optimizing the specified objective, ART finds a set of recommendations by
art.recommend(draws)
   which ensures that each recommendation is different from all others and all input data by a factor of γ (rel_eng_accuracy) in at least one of the components (see Algorithm 1).

Algorithm 1 Choosing recommendations from a set of samples from the target distribution π(x)

| | |
|---|---|
| 1: | Input: Nᵣ: number of recommendations |
| | {xₙ}ₙ₌₁^{Ns}: samples from π(x) (Eq. 4) |
| | γ: required relative distance for recommendations (relative engineering accuracy) |
| | [symbol] ₓ: input variable experimental data |
| 2: | Output: rec = {x^{r}}ᵣ₌₁^{Nr}: set of recommendations |
| 3: | draws ← {xₙ}ₙ₌₁^{Ns} {remaining draws} |
| 4: | rec = ø |
| 5: | while r = 1, . . . , Nᵣ do |
| 6: | if draws = ø then |
| 7: | γ = 0.8γ and repeat the procedure |
| 8: | else |
| 9: | x^{r} ← a sample from draws with maximal G(x) {G (x) is already calculated} |
| 10: | if there exists d ∈ {1, . . . , D} s.t. \|x_{d}^{r} − x_{d}\| > γ for all x ∈ rec ∪ [symbol] ₓ then |
| 11: | rec = {rec,x^{r}} |
| 12: | end if |
| 13: | end if |
| 14: | draws ← draws \ {xₙ ∈ draws\|G(xₙ) = G(x^{r})} |
| 15: | end while |
| 16: | return rec |

### Documentation and Testing

The ART source code thoroughly conforms to the syntactic and stylistic specifications outlined in the PEP 8 style guide. Documentation for class methods and utility functions is embedded in docstrings. A brief synopsis of functionality, an optional deeper dive into behavior and use cases, as well as a full description of parameter and return value typing is included in the flexible reStructuredText markup syntax. The documented source code is used in conjunction with the Sphinx package to dynamically generate an API reference.

The code can be built as a local package for testing and other utility, the dependencies and procedure for which are handled by the setup.py file in accordance with the Setuptools standard for module installation.

A suite of unit and integration tests were written using the pytest library, and are included with the source code under the tests directory. The unit testing was designed to target and rigorously validate individual functions in their handling and output of types. Because of the expensive calls to libraries such as scikit-learn and tpot in this example laden throughout ART's codebase for model training and validation, unit-tested functions were parameterized with the Boolean flag testing to replace such calls with dummy data that mimic the responses from library code. The resulting suite of unit tests therefore runs rapidly, quickly evaluating the integrity of type handling and output that ensure the smooth hand-off of values between functions in ART.

Integration tests are likewise implemented with pytest, but rather test a more complete spectrum of expected behavior without silencing calls to library code. Full model training, cross-validation, and evaluation is completed under this test suite, the output of which is validated against known data sets within some reasonable margin to account for stochastic processes.

The instructions to locally run the testing suite can be found in the documentation.

### Results and Discussion

### Using Simulated Data to Test ART

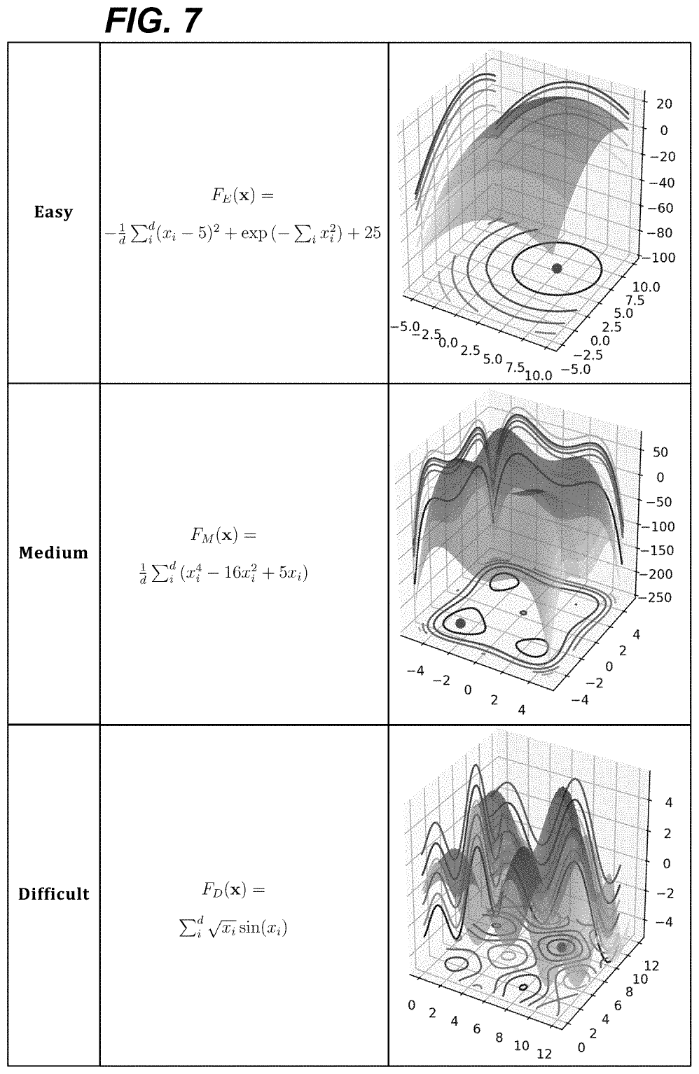

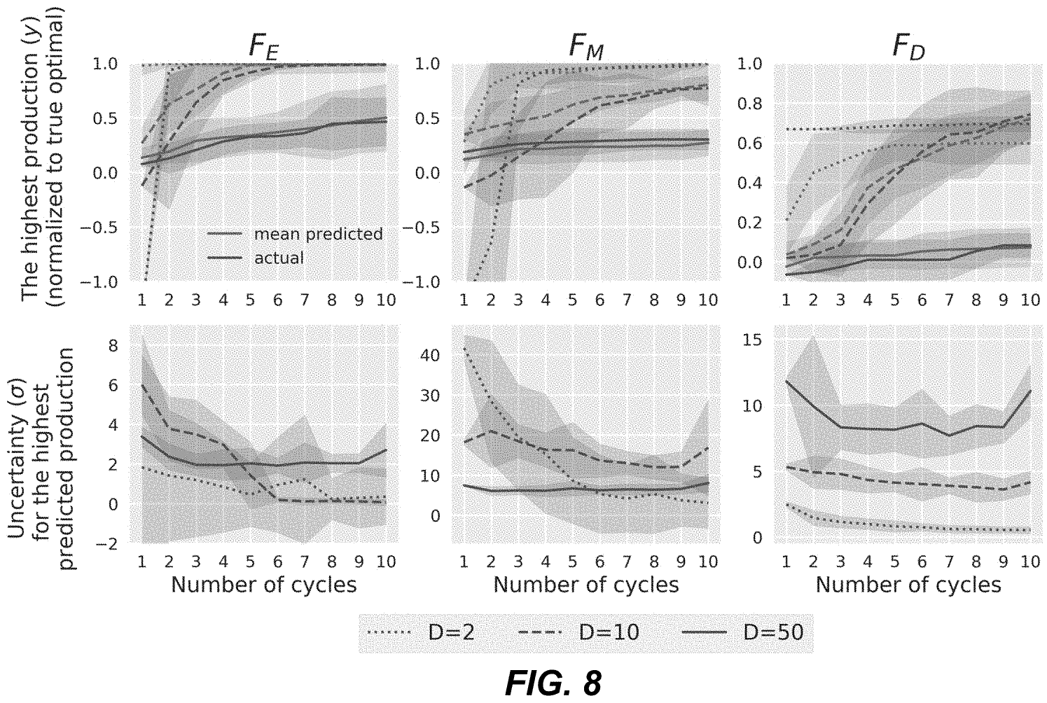

Synthetic data sets allowed testing how ART performs when confronted by problems of different difficulty and dimensionality, as well as gauge the effect of the availability of more training data. In this case, the performance of ART was tested for 1-10 DBTL cycles, three problems of increasing difficulty (F_{E}, F_{M} and F_{D}, see FIG. 7), and three different dimensions of input space (D=2, 10, and 50, FIG. 8). The DBTL processes were simulated by starting with a training set given by 16 strains (Latin Hypercube draws) and the associated measurements (from FIG. 7 functions). The maximization case was investigated, and at each DBTL cycle, 16 recommendations that maximize the objective function given by Eq. 3 were generated. This choice mimicked triplicate experiments in the 48 wells of throughput of a typical automated fermentation platform. A tempering strategy for the exploitation-exploration parameter was used: assign α=0.9 at start for an exploratory optimization, and gradually decreased the value to α=0 in the final DBTL cycle for the exploitative maximization of the production levels.

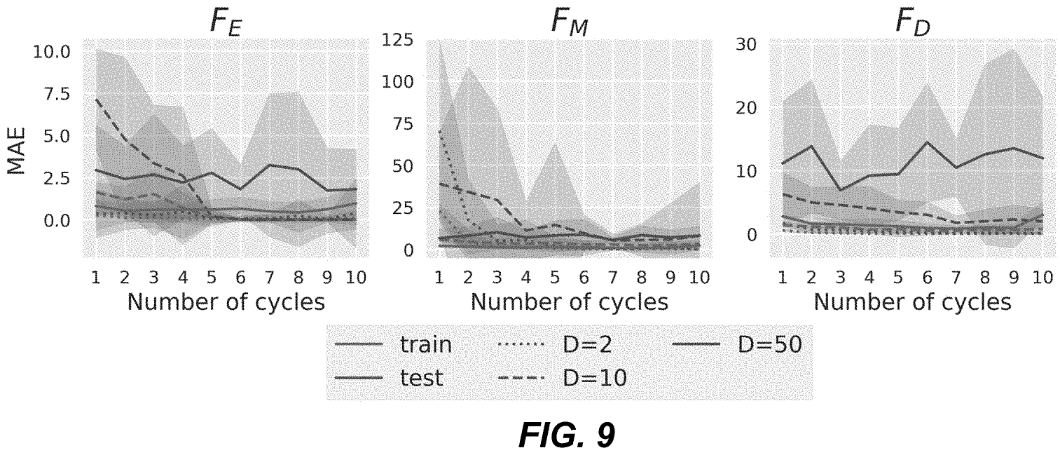

ART performance improved significantly as more data were accrued with additional DTBL cycles. Whereas the prediction error, given in terms of Mean Average Error (MAE), remained constantly low for the training set (ART was always able to reliably predict data it had already seen), the MAE for the test data (data ART had not seen) in general decreased markedly only with the addition of more DBTL cycles (FIG. 9). The exceptions were the most complicated problems: those exhibiting highest dimensionality (D=50), where MAE stayed approximately constant, and the difficult function F_{D}, which exhibited a slower decrease. Furthermore, the best production among the 16 recommendations obtained in the simulated process increased monotonically with more DBTL cycles: faster for easier problems and lower dimensions and more slowly for harder problems and higher dimensions. Finally, the uncertainty in those predictions decreased as more DBTL cycles proceed (FIG. 8). Hence, more data (DBTL cycles) almost always translated into better predictions and production. However, these benefits were rarely reaped with only the 2 DBTL cycles customarily used in metabolic engineering (see demonstration cases in the next sections). Thus, ART can become truly efficient when using 5-10 DBTL cycles.

Different experimental problems involve different levels of difficulty when being learnt (being predicted accurately), and the difficulty can be assessed empirically. Low dimensional problems can be easily learnt, whereas exploring and learning a 50-dimensional landscape was very slow (FIG. 8). Difficult problems (less monotonic landscapes) took more data to learn and traverse than easier ones. This example showcase this point in terms of real experimental data when comparing the biofuel project (easy) versus the dodecanol project (hard) below. However, deciding a priori whether a given real data project or problem will be easy or hard to learn can be difficult. One way to determine this is by checking the improvements in prediction accuracy as more data is added. A starting point of at least about 100 instances can ensure proper statistics.

FIG. 7. Functions presenting different levels of difficulty to being learnt, used to produce synthetic data and test ART's performance (FIG. 8).

FIG. 8. ART performance improves significantly by proceeding beyond the usual two Design-Build-Test-Learn cycles. The results of testing ART's performance are shown with synthetic data obtained from functions of different levels of complexity (see FIG. 7), different phase space dimensions (2, 10 and 50), and different amounts of training data (DBTL cycles). The top row presents the results of the simulated metabolic engineering in terms of highest production achieved so far for each cycle (as well as the corresponding ART predictions). The production increased monotonically with a rate that decreased as the problem was harder to learn, and the dimensionality increases. The bottom row shows the uncertainty in ART's production prediction, given by the standard deviation of the response distribution (Eq. 2). This uncertainty decreased markedly with the number of DBTL cycles, except for the highest number of dimensions. In each plot, lines and shaded areas represent the estimated mean values and 95% confidence intervals, respectively, over 10 repeated runs. Mean Absolute Error (MAE) and training and test set definitions can be found in FIG. 9.

FIG. 9. Mean Absolute Error (MAE) for the synthetic data set in FIG. 8. Synthetic data was obtained from functions of different levels of complexity (see FIG. 7), different phase space dimensions (2, 10 and 50), and different amounts of training data (DBTL cycles). The training set involved all the strains from previous DBTL cycles. The test set involved the recommendations from the current cycle. MAE was obtained by averaging the absolute difference between predicted and actual production levels for these strains. MAE decreased significantly as more data (DBTL cycles) were added, with the exception of the high dimension case. In each plot, lines and shaded areas represent the estimated mean values and 95% confidence intervals, respectively, over 10 repeated runs.

### Improving the Production of Renewable Biofuel

The optimization of the production of the renewable biofuel limonene through synthetic biology is a demonstration of ART using real-life experimental data. Renewable biofuels are almost carbon neutral because renewable biofuels only release into the atmosphere the carbon dioxide that was taken up in growing the plant biomass renewable biofuels are produced from. Biofuels from renewable biomass have been estimated to be able to displace about 30% of petroleum consumption and are seen as the most viable option for decarbonizing sectors that are challenging to electrify, such as heavy-duty freight and aviation.

Limonene is a molecule that can be chemically converted to several pharmaceutical and commodity chemicals. If hydrogenated, for example, it has low freezing point and is immiscible with water, characteristics which are ideal for next generation jet-biofuels and fuel additives that enhance cold weather performance. Limonene has been traditionally obtained from plant biomass, as a byproduct of orange juice production, but fluctuations in availability, scale and cost limit its use as biofuel. The insertion of the plant genes responsible for the synthesis of limonene in a host organism (e.g., a bacteria), however, offers a scalable and cheaper alternative through synthetic biology. Limonene has been produced in E. coli through an expansion of the celebrated mevalonate pathway, used to produce the antimalarial precursor artemisinin and the biofuel farnesene, and which forms the technological base on which the company Amyris was founded (valued about $300M in 2019). This version of the mevalonate pathway is composed of seven genes obtained from such different organisms as S. cerevesiae, S. aureus, and E. coli, to which two genes have been added: a geranyl-diphosphate synthase and a limonene synthase obtained from the plants A. grandis and M. spicata, respectively.

For this demonstration case, historical data was used, where 27 different variants of the pathway (using different promoters, induction times and induction strengths) were built. Data collected for each variant involved limonene production and protein expression for each of the nine proteins involved in the synthetic pathway. These data were used to feed Principal Component Analysis of Proteomics (PCAP), an algorithm using principal component analysis to suggest new pathway designs. The PCAP recommendations, used to engineer new strains, resulted in a 40% increase in production for limonene, and 200% for bisabolene (a molecule obtained from the same base pathway). This small number of available instances (27 in this demonstration case) to train the algorithms is typical of synthetic biology/metabolic engineering projects. The lack of large amounts of data can determine the machine learning approach in ART (e.g., no deep neural networks).

ART was able to not only recapitulate the successful predictions obtained by PCAP improving limonene production, but also provided a systematic way to obtain them as well as the corresponding uncertainty. In this case, the training data for ART were the concentrations for each of the nine proteins in the heterologous pathway (input), and the production of limonene (response). The objective was to maximize limonene production. Data for two DBTL cycles were available, and what would have happened if ART was used instead of PCAP for this project was explored.

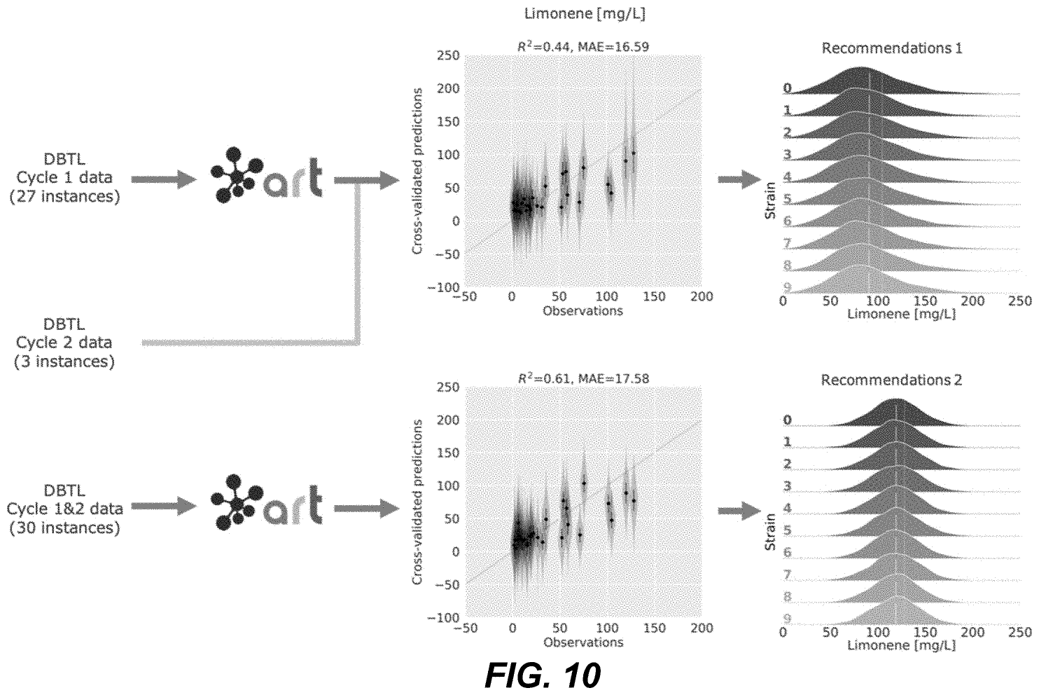

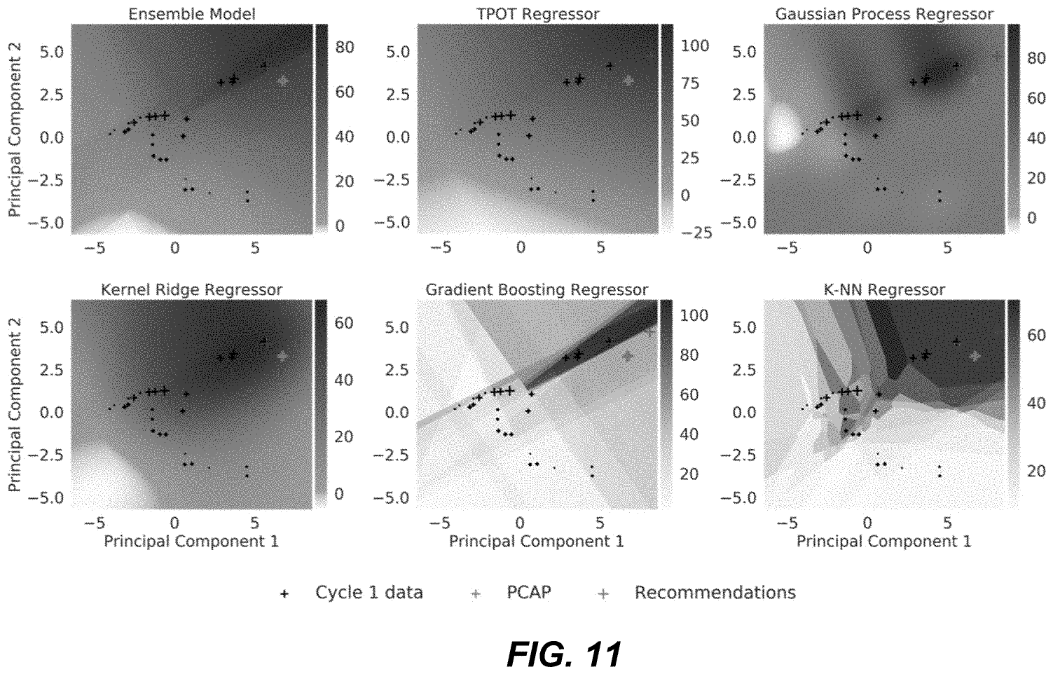

The data from DBLT cycle 1 was used to train ART and recommend new strain designs (protein profiles for the pathway genes, FIG. 10). The model trained with the initial 27 instances provided reasonable cross-validated predictions for production of this set (R²=0.44), as well as the three strains which were created for DBTL cycle 2 at the behest of PCAP (FIG. 10). This suggests that ART would have easily recapitulated the PCAP results. Indeed, the ART recommendations were very close to the PCAP recommendations (FIG. 11). Interestingly, while the quantitative predictions of each of the individual models were not very accurate, the models all signaled towards the same direction in order to improve production, hence showing the importance of the ensemble approach (FIG. 11).

Training ART with experimental results from DBTL cycles 1 and 2 resulted in even better predictions (R²=0.61), highlighting the importance of the availability of large amounts of data to train ML models. This new model suggested new sets of strains predicted to produce even higher amounts of limonene. Importantly, the uncertainty in predicted production levels was significantly reduced with the additional data points from cycle 2.

FIG. 10. ART provided effective recommendations to improve renewable biofuel (limonene) production. The first DBTL cycle data (27 strains, top) was used to train ART and recommend new protein targets (top right). The ART recommendations were very similar to the protein profiles that eventually led to a 40% increase in production (FIG. 11). ART predicted mean production levels for the second DBTL cycle strains which were very close to the experimentally measured values (three blue points in top graph). Adding those three points from DBTL cycle 2 provided a total of 30 strains for training that led to recommendations predicted to exhibit higher production and narrower distributions (bottom right). Uncertainty for predictions is shown as probability distributions for recommendations and violin plots for the cross-validated predictions. R² and Mean Absolute Error (MAE) values are for cross-validated mean predictions (black data points).

FIG. 11. All machine learning algorithms pointed in the same direction to improve limonene production, in spite of quantitative differences in prediction. Cross sizes indicate experimentally measured limonene production in the proteomics phase space (first two principal components shown from principal component analysis, PCA). The color heatmap indicates the limonene production predicted by a set of base regressors and the final ensemble model (top left) that leverages all the models and conforms the base algorithm used by ART. Although the models differed significantly in the actual quantitative predictions of production, the same qualitative trends can be seen in all models (explore upper right quadrant for higher production), justifying the ensemble approach used by ART. The ART recommendations (green) were very close to the PCAP recommendations (red) that were experimentally tested to improve production by 40%.

Brewing Hoppy Beer without Hops by Bioengineering Yeast

The second demonstration case involved bioengineering yeast (S. cerevisiae) to produce hoppy beer without the need for hops. To this end, the ethanol-producing yeast used to brew the beer, was modified to also synthesize the metabolites linalool (L) and geraniol (G), which impart hoppy flavor. Synthesizing linalool and geraniol through synthetic biology is economically advantageous because growing hops is water and energetically intensive, and their taste is highly variable from crop to crop. Indeed, a startup (Berkeley Brewing Science) was generated from this technology.

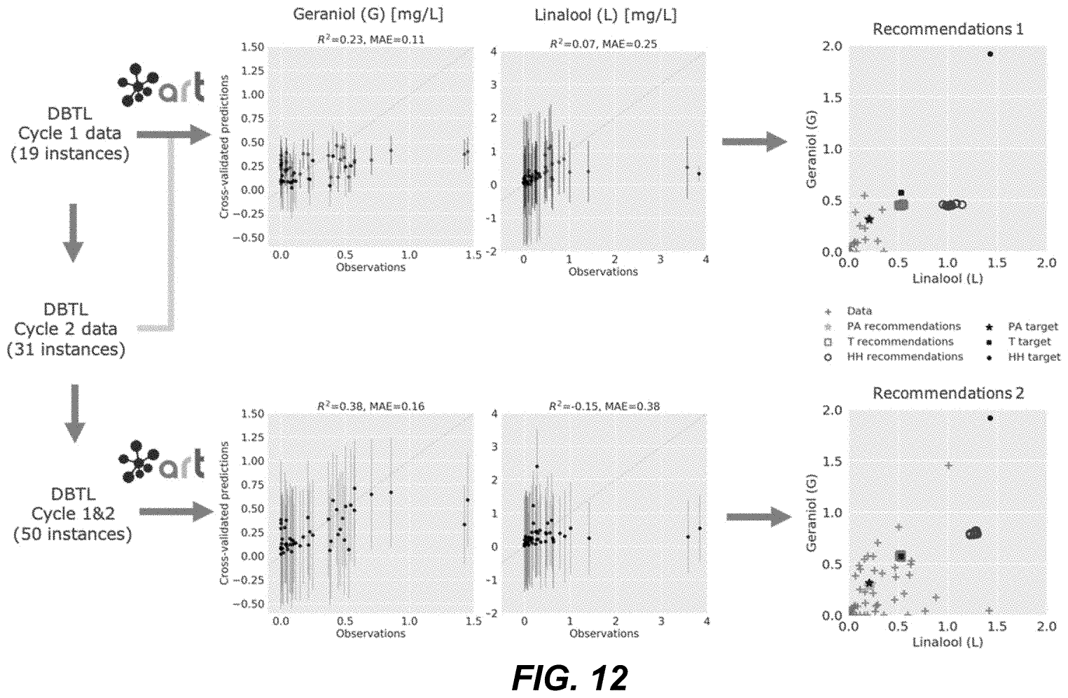

ART was able to efficiently provide the proteins-to-production mapping that required three different types of mathematical models in the original publication, paving the way for a systematic approach to beer flavor design. The challenge was different in this case as compared to the previous demonstration case (limonene): instead of trying to maximize production, the goal was to reach a particular level of linalool and geraniol so as to match a known beer tasting profile (e.g., Pale Ale, Torpedo or Hop Hunter, FIG. 12). ART can provide this type of recommendations, as well. For this case, the inputs were the expression levels for the four different proteins involved in the pathway, and the response are the concentrations of the two target molecules (L and G) with desired targets. Data for two DBTL cycles involving 50 different strains/instances (19 instances for the first DBTL cycle and 31 for the second one, FIG. 12) were available. As in the previous case, this data was used to simulate the outcomes that would have been obtained in case ART had been available for this project.

The first DBTL cycle provided a very limited number of 19 instances to train ART, which performed passably on this training set, and poorly on the test set provided by the 31 instances from DBTL cycle 2 (FIG. 12). Despite this small amount of training data, the model trained in DBTL cycle 1 was able to recommend new protein profiles that were predicted to reach the Pale Ale target (FIG. 12). Similarly, this DBTL cycle 1 model was almost able to reach (in predictions) the L and G levels for the Torpedo beer, which would be finally achieved in DBTL cycle 2 recommendations, once more training data was available. For the Hop Hunter beer, recommendations from this model were not close to the target.

The model for the second DBTL cycle leveraged the full 50 instances from cycles 1 and 2 for training and was able to provide recommendations predicted to attain two out of three targets. The Pale Ale target L and G levels were already predicted to be matched in the first cycle; the new recommendations were able to maintain this beer profile. The Torpedo target was almost achieved in the first cycle, and was predicted to be reached in the second cycle recommendations. Finally, Hop Hunter target L and G levels were very different from the other beers and cycle 1 results, so neither cycle 1 or 2 recommendations can predict protein inputs achieving this taste profile. ART had only seen two instances of high levels of L and G and cannot extrapolate well into that part of the metabolic phase space. ART's exploration mode, however, can suggest experiments to explore this space.

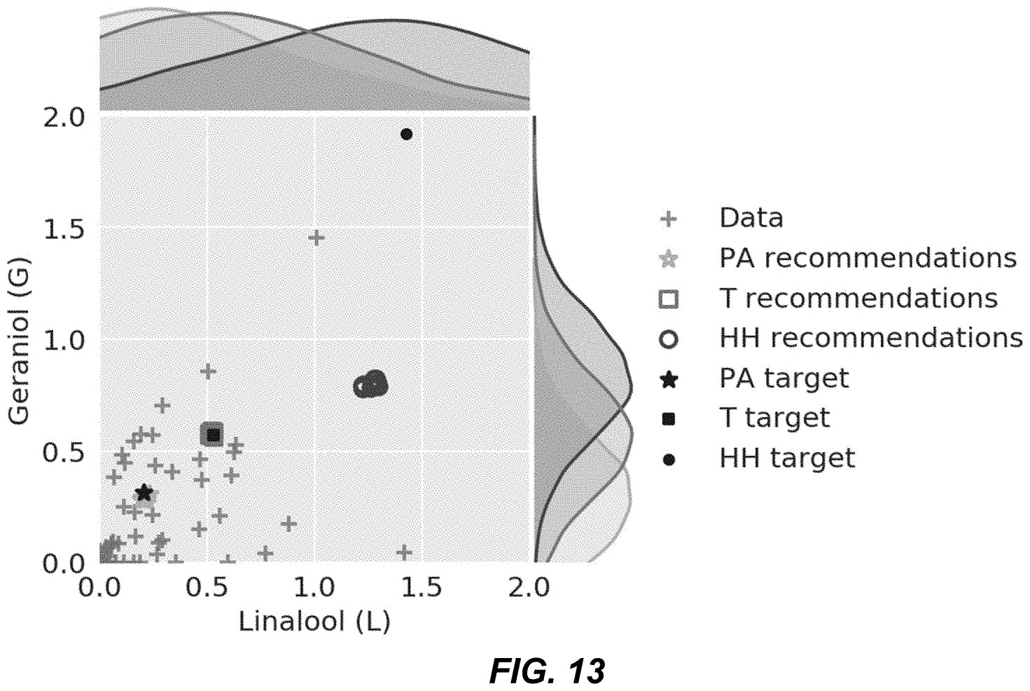

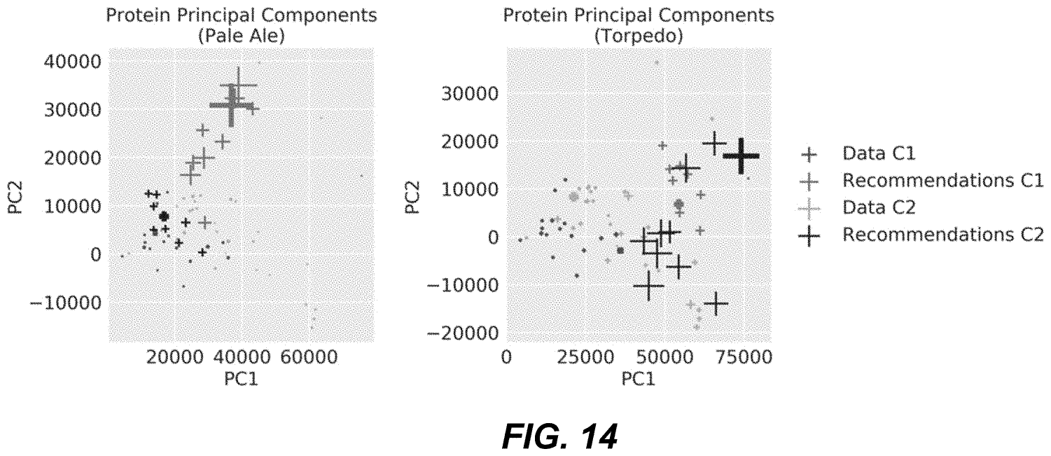

Quantifying the prediction uncertainty was of fundamental importance to gauge the reliability of the recommendations, and the full process through several DBTL cycles. In the end, the fact that ART was able to recommend protein profiles predicted to match the Pale Ale and Torpedo taste profiles indicated that the optimization step (see “Optimization: suggesting next steps” section) worked well. The actual recommendations, however, were as good as the predictive model. In this regard, the predictions for L and G levels shown in FIG. 12 (right side) may seem deceptively accurate, since the predictions for L and G levels were only showing the average predicted production. Examining the full probability distribution provided by ART showed a very broad spread for the L and G predictions (much broader for L than G, FIG. 13). These broad spreads indicate that the model still had not converged and that recommendations may change significantly with new data. Indeed, the protein profile recommendations for the Pale Ale changed markedly from DBTL cycle 1 to 2, although the average metabolite predictions did not (left panel of FIG. 14). All in all, these considerations indicate that quantifying the uncertainty of the predictions is important to foresee the smoothness of the optimization process.

At any rate, despite the limited predictive power afforded by the cycle 1 data, ART recommendations guided metabolic engineering effectively. For both of the Pale Ale and Torpedo cases, ART recommended exploring parts of the proteomics phase space such that the final protein profiles (that were deemed close enough to the targets), lied between the first cycle data and these recommendations (FIG. 14). Finding the final target would become, then, an interpolation problem, which is much easier to solve than an extrapolation one. These recommendations improved as ART becomes more accurate with more DBTL cycles.

FIG. 12. ART produced effective recommendations to bioengineer yeast to produce hoppy beer without hops. The 19 instances in the first DBTL cycle were used to train ART, but it did not show an impressive predictive power (particularly for L, top middle). In spite of it, ART was still able to recommend protein profiles predicted to reach the Pale Ale (PA) target flavor profile, and others which were close to the Torpedo (T) metabolite profile (top right, green points showing mean predictions). Adding the 31 strains for the second DBTL cycle improved predictions for G but not for L (bottom). The expanded range of values for G & L provided by cycle 2 allowed ART to recommend profiles which were predicted to reach targets for both beers (bottom right), but not Hop Hunter (HH). Hop Hunter displays a very different metabolite profile from the other beers, well beyond the range of experimentally explored values of G & L, making it difficult for ART to extrapolate that far. Notice that none of the experimental data (red crosses) matched exactly the desired targets (black symbols), but the closest ones were considered acceptable. R² and Mean Absolute Error (MAE) values are for cross-validated mean predictions (black data points). Bars indicate 95% credible interval of the predictive posterior distribution.

FIG. 13. Linalool and geraniol predictions for ART recommendations for each of the beers (FIG. 12), showing full probability distributions (not just averages). These probability distributions (in different tones of green for each of the three beers) show very broad spreads, belying the illusion of accurate predictions and recommendations. These broad spreads indicate that the model had not converged yet and that many production levels were compatible with a given protein profile.

FIG. 14. Principal Component Analysis (PCA) of proteomics data for the hopless beer project (FIG. 12), showing experimental results for cycle 1 and 2, as well as ART recommendations for both cycles. Cross size is inversely proportional to proximity to L and G targets (larger crosses are closer to target). The broad probability distributions spreads (FIG. 13) suggest that recommendations may change significantly with new data. Indeed the protein profile recommendations for the Pale Ale changed markedly from DBTL cycle 1 to 2, even though the average metabolite predictions did not (FIG. 12, right column). For the Torpedo case, the final protein profile recommendations overlapped with the experimental protein profiles from cycle 2, although the final protein profile recommendations did not cluster around the closest profile (largest orange cross), concentrating on a better solution according to the model. In any case, despite the limited predictive power afforded by the cycle 1 data, ART produced recommendations that guide the metabolic engineering effectively. For both of these cases, ART recommended exploring parts of the phase space such that the final protein profiles that were deemed close enough to the targets (in orange, see also bottom right of FIG. 10) lied between the first cycle data (red) and these recommendations (green). In this way, finding the final target (expected around the orange cloud) would become an interpolation problem, which is easier to solve than an extrapolation one.

### Improving Dodecanol Production

The third demonstration case is one with a mitigated success, from which as much can be learnt as from the previous successes. Machine learning was previously used to drive two DBTL cycles to improve production of 1-dodecanol in E. coli, a medium-chain fatty acid used in detergents, emulsifiers, lubricants and cosmetics. This demonstration case illustrates the case in which the assumptions underlying this metabolic engineering and modeling approach (mapping proteomics data to production) may not hold true. Although a ˜20% production increase was achieved, the machine learning algorithms were not able to produce accurate predictions with the low amount of data available for training, and the tools available to reach the desired target protein levels were not accurate enough.

This project included two DBTL cycles comprising 33 and 21 strains, respectively, for three alternative pathway designs (Table 4). The use of replicates increased the number of instances available for training to 116 and 69 for cycle 1 and 2, respectively. The goal was to modulate the protein expression by choosing Ribosome Binding Sites (RBSs, the mRNA sites to which ribosomes bind in order to translate proteins) of different strengths for each of the three pathways. The idea was for the machine learning to operate on a small number of variables (about 3 RBSs) that, at the same time, provided significant control over the pathway. As in previous cases, this demonstration case shows how ART could have been used in this project. The input for ART in this case included the concentrations for each of three proteins (different for each of the three pathways), and the goal was to maximize 1-dodecanol production.

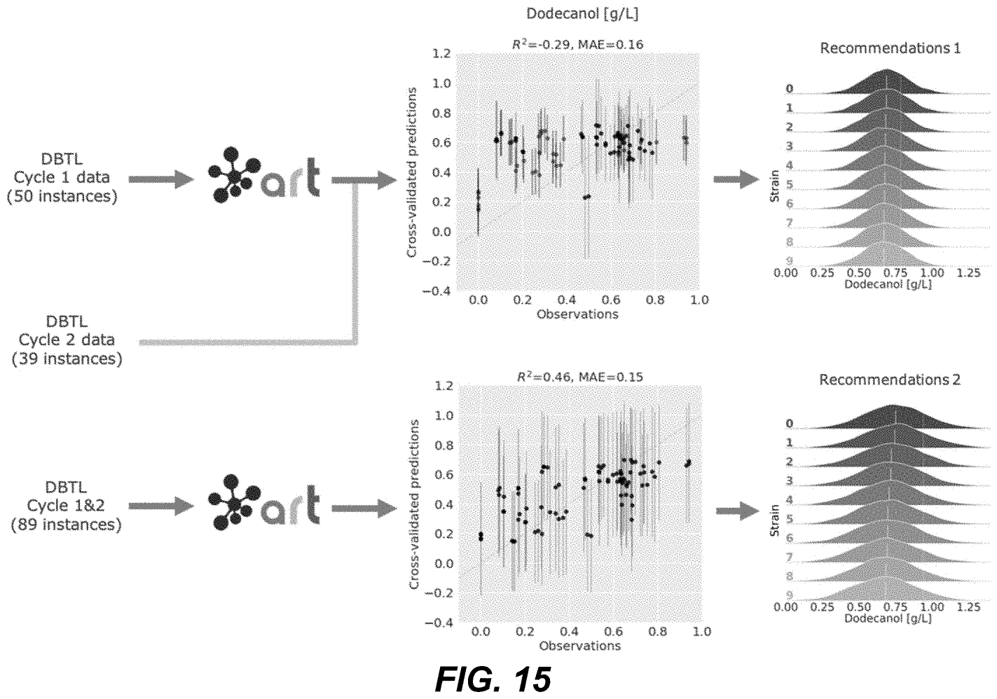

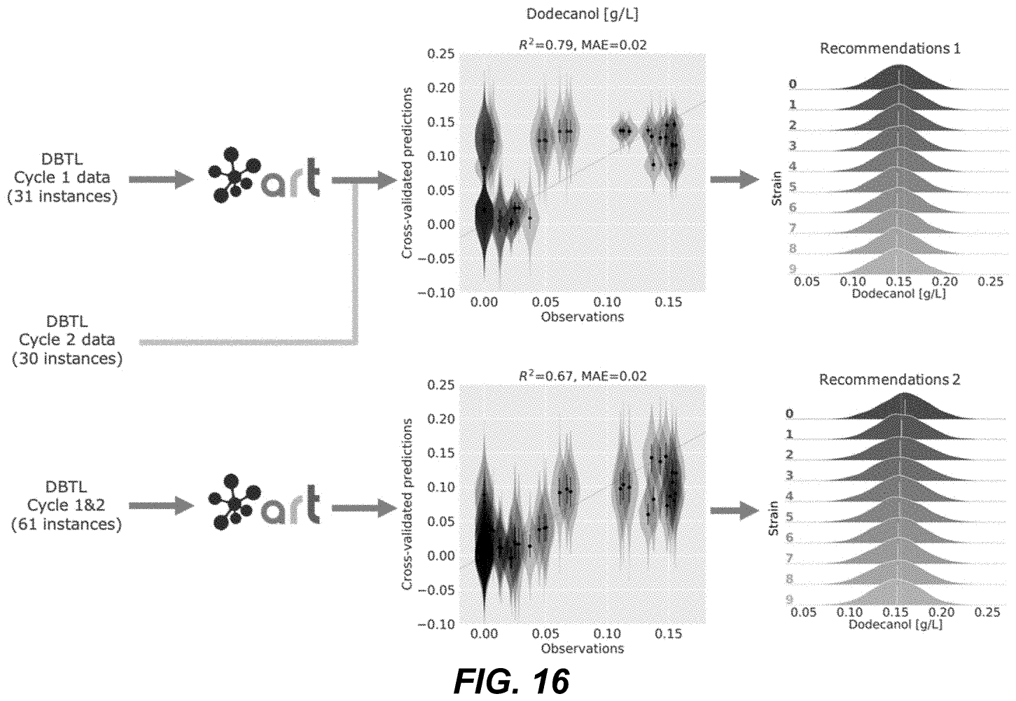

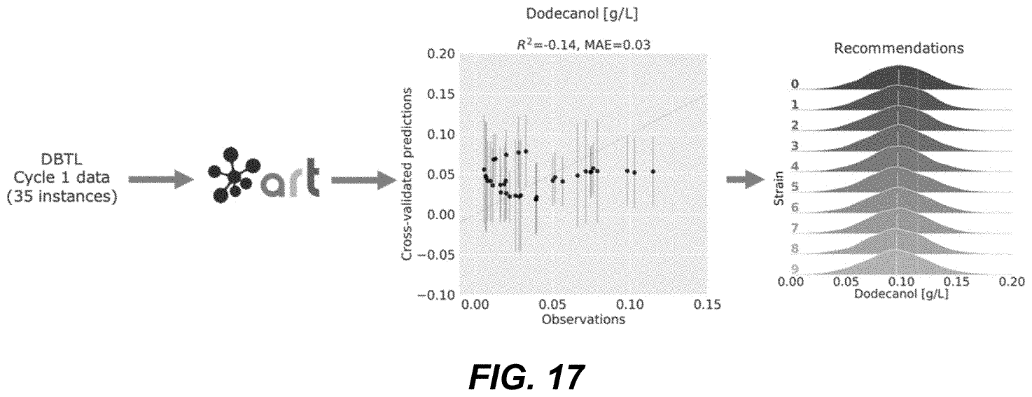

TABLE 4
Total number of strains (pathway designs) and training instances available
for the dodecanol production study (FIG. 15, FIG. 16, and FIG. 17).
Training instances were amplified by the use of fermentation replicates.
Failed constructs (3 in each cycle, initial designs were for 36 and
24 strains in cycle 1 and 2) indicate nontarget, possibly toxic, effects
related to the chosen designs. Numbers in parentheses ( ) indicate
cases for which no product (dodecanol) was detected.

| | |
|---|---|
| Number of strains | Number of instances |

| | Cycle 1 | Cycle 2 | Cycle 1 | Cycle 2 |
|---|---|---|---|---|
| Pathway 1 | 12 | 11 (2) | 50 | 39 (6) |
| Pathway 2 | 9 (4) | 10 (5) | 31 (10) | 30 (14) |
| Pathway 3 | 12 | — | 35 | — |
| Total | 33 (4) | 21 (7) | 116 (10) | 69 (20) |

The first challenge involved the limited predictive power of machine learning for this case. This limitation is shown by ART's completely compromised prediction accuracy (FIG. 15). Without being bound by any particular theory, the causes seem to be twofold: a small training set and a strong connection of the pathway to the rest of host metabolism. The initial 33 strains (116 instances) were divided into three different designs (Table 4), decimating the predictive power of ART (FIG. 15, FIG. 16, and FIG. 17). Now, estimating the number of strains needed for accurate predictions was complicated because that depended on the complexity of the problem to be learnt (see “Using simulated data to test ART” section). In this case, the problem is harder to learn than the previous two demonstration cases: the mevalonate pathway used in those demonstration cases is fully exogenous (built from external genetic parts) to the final yeast host and hence, free of the metabolic regulation that is certainly present for the dodecanol producing pathway. The dodecanol pathway depends on fatty acid biosynthesis which is vital for cell survival (fatty acids are present in the cell membrane), and has to be therefore tightly regulated. This characteristic makes ART learning using only dodecanol synthesis pathway protein levels (instead of adding also proteins from other parts of host metabolism) difficult.

A second challenge, compounding the first one, involved the inability to reach the target protein levels recommended by ART to increase production. This difficulty precluded not only bioengineering, but also testing the validity of the ART model. For this project, both the mechanistic (RBS calculator) and machine learning-based (EMOPEC) tools proved to be very inaccurate for bioengineering purposes: e.g., a prescribed 6-fold increase in protein expression could only be matched with a 2-fold increase. Moreover, non-target effects (changing the RBS for a gene significantly affects protein expression for other genes in the pathway) were abundant, further adding to the difficulty. While unrelated directly to ART performance, these effects highlight the importance of having enough control over ART's input (proteins in this case) to obtain satisfactory bioengineering results.

A third, unexpected, challenge was the inability of constructing several strains in the Build phase due to toxic effects engendered by the proposed protein profiles (Table 4). This phenomenon materialized through mutations in the final plasmid in the production strain or no colonies after the transformation. The prediction of these effects in the Build phase represents an important target for future ML efforts. A better understanding of this phenomenon may not only enhance bioengineering but also reveal new fundamental biological knowledge.

These challenges highlight the importance of carefully considering the full experimental design before leveraging machine learning to guide metabolic engineering.

FIG. 15. ART's predictive power was heavily compromised in the dodecanol production demonstration case. Although the 50 instances available for cycle 1 (top) almost double the 27 available instances for the limonene case (FIG. 10), the predictive power of ART was heavily compromised (R²=−0.29 for cross-validation) by the strong tie of the pathway to host metabolism (fatty acid production), and the scarcity of data. The poor predictions for the test data from cycle 2 (in blue) confirmed the lack of predictive power. Adding data from both cycles (1 and 2) improved predictions notably (bottom). The cases for the other two pathways produced similar conclusions (FIG. 16 and FIG. 17). R² and Mean Absolute Error (MAE) values are for cross-validated mean predictions (black data points). Bars indicate 95% credible interval of the predictive posterior distribution.

FIG. 16. ART's predictive power for the second pathway in the dodecanol production demonstration case was very limited. Although cycle 1 data provide good cross-validated predictions, testing the model with 30 new instances from cycle 2 (in blue) shows limited predictive power and generalizability. As in the case of the first pathway (FIG. 15), combining data from cycles 1 and 2 improves predictions significantly.

FIG. 17 ART's predictive power for the third pathway in the dodecanol production demonstration case was poor. As in the case of the first pathway (FIG. 15), the predictive power using 35 instances is minimal. The low production for this pathway preempted a second cycle.

### Data Availability

The experimental data analyzed in this example can be found both in the Experiment Data Depot, in the following (the content of each of which is incorporated herein by reference in its entirety)

| Study | Link |
|---|---|
| Biofuel | public-edd.jbei.org/s/pcap/ |
| Hopless beer | public-edd.agilebiofoundry.org/s/hopless-beer/ |
| | public-edd.agilebiofoundry.org/s/hopless-beer-cycle-2/ |
| Dodecanol | public-edd.jbei.org/s/ajinomoto/ |

and as .csv files in github.com/JBEI/ART (the content of which is incorporated herein by reference in its entirety).

### Conclusion

ART is a tool that not only provides synthetic biologists easy access to machine learning techniques, but can also systematically guide bioengineering and quantify uncertainty. ART takes as input a set of vectors of measurements (e.g., a set of proteomics measurements for several proteins, or transcripts for several genes) along with their corresponding systems responses (e.g., associated biofuel production) and provides a predictive model, as well as recommendations for the next round (e.g., new proteomics targets predicted to improve production in the next round).

ART in this example combines the methods from the scikit-learn library with a novel Bayesian ensemble approach and MCMC sampling, and is optimized for the conditions encountered in metabolic engineering: small sample sizes, recursive DBTL cycles and the need for uncertainty quantification. ART's approach involves an ensemble where the weight of each model is considered a random variable with a probability distribution inferred from the available data. Unlike other approaches, this method does not require the ensemble models to be probabilistic in nature, hence allowing fully exploiting, for example, the scikit-learn library to increase accuracy by leveraging a diverse set of models. This weighted ensemble model produces a simple, yet powerful, approach to quantify uncertainty (FIG. 2), a critical capability when dealing with small data sets and a crucial component of AI in biological research. While ART is adapted to synthetic biology's special needs and characteristics, its implementation is general enough that it is easily applicable to other problems of similar characteristics. ART is perfectly integrated with the Experiment Data Depot and the Inventory of Composable Elements, forming part of a growing family of tools that standardize and democratize synthetic biology.

This example showcases the use of ART in a case with synthetic data sets and three real metabolic engineering cases from the published literature. The synthetic data case involved data generated for several production landscapes of increasing complexity and dimensionality. This case allowed testing ART for different levels of difficulty of the production landscape to be learnt by the algorithms, as well as different numbers of DBTL cycles. While easy landscapes provided production increases readily after the first cycle, more complicated ones required more than 5 cycles to start producing satisfactory results (FIG. 8). In all cases, results improved with the number of DBTL cycles, underlying the importance of designing experiments that continue for ˜10 cycles rather than halting the project if results did not improve in the first few cycles.

The demonstration cases using real data involve engineering E. coli and S. cerevisiae to produce the renewable biofuel limonene, synthesize metabolites that produce hoppy flavor in beer, and generate dodecanol from fatty acid biosynthesis. Although ART was able to produce useful recommendations with as low as 27 (limonene, FIG. 10) or 19 (hopless beer, FIG. 12) instances, situations in which larger amounts of data (50 instances) were insufficient for meaningful predictions (dodecanol, FIG. 15). Determine a priori how much data will be necessary for accurate predictions can be difficult, since this depends on the difficulty of the relationships to be learnt (e.g., the amount of coupling between the studied pathway and host metabolism). However, one thing is clear—two DBTL cycles (which was as much as was available for all these demonstration cases) are rarely sufficient for guaranteed convergence of the learning process. This example found, though, that accurate quantitative predictions are not required to effectively guide bioengineering—our ensemble approach can successfully leverage qualitative agreement between the models in the ensemble to compensate for the lack of accuracy (FIG. 11). Uncertainty quantification was critical to gauge the reliability of the predictions (FIG. 10), anticipate the smoothness of the recommendation process through several DBTL cycles (FIG. 13 and FIG. 14), and effectively guide the recommendations towards the least understood part of the phase space (exploration case, FIG. 3). This example explored several ways in which the current approach (mapping—omics data to production) can fail when the underlying assumptions break down. Without being bound by any particular theory, among the possible pitfalls is the possibility that recommended target protein profiles cannot be accurately reached, since the tools to produce specified protein levels are still imperfect; or because of biophysical, toxicity or regulatory reasons. These areas need further investment in order to accelerate bioengineering and make it more reliable, hence enabling design to a desired specification.

### Additional Considerations

In at least some of the previously described embodiments, one or more elements used in an embodiment can interchangeably be used in another embodiment unless such a replacement is not technically feasible. It will be appreciated by those skilled in the art that various other omissions, additions and modifications may be made to the methods and structures described above without departing from the scope of the claimed subject matter. All such modifications and changes are intended to fall within the scope of the subject matter, as defined by the appended claims.

One skilled in the art will appreciate that, for this and other processes and methods disclosed herein, the functions performed in the processes and methods can be implemented in differing order. Furthermore, the outlined steps and operations are only provided as examples, and some of the steps and operations can be optional, combined into fewer steps and operations, or expanded into additional steps and operations without detracting from the essence of the disclosed embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. As used in this specification and the appended claims, the singular forms “a,” “an,” and “the” include plural references unless the context clearly dictates otherwise. Accordingly, phrases such as “a device configured to” are intended to include one or more recited devices. Such one or more recited devices can also be collectively configured to carry out the stated recitations. For example, “a processor configured to carry out recitations A, B and C can include a first processor configured to carry out recitation A and working in conjunction with a second processor configured to carry out recitations B and C. Any reference to “or” herein is intended to encompass “and/or” unless otherwise stated.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

It will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (for example, not all described acts or events are necessary for the practice of the algorithms). Moreover, in certain embodiments, acts or events can be performed concurrently, for example through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure and protected by the following claims.

1. A system for training a probabilistic predictive model for recommending experiment designs for synthetic biology comprising:
non-transitory memory configured to store executable instructions; and
a hardware processor in communication with the non-transitory memory, the hardware processor programmed by the executable instructions to:
receive synthetic biology experimental data;
generate training data from the synthetic biology experimental data, wherein the training data comprise a plurality of training inputs and corresponding reference outputs, wherein each of the plurality of training inputs comprises training values of input variables, and wherein each of the plurality of reference outputs comprises a reference value of at least one response variable associated with a predetermined response variable objective;
train, using the training data, a plurality of level-0 learners of a probabilistic predictive model for recommending experiment designs for synthetic biology, wherein an input of each of the plurality of level-0 learners comprises input values of the input variables, and wherein an output of each of the plurality of level-0 learners comprises a predicted value of at least one response variable; and
train, using (i) predicted values of the at least one response variable determined using the plurality of level-0 learners for the training inputs of the plurality of training inputs, and (ii) the reference outputs of the plurality of reference outputs correspondence to the training inputs of the plurality of training inputs, a level-1 learner of the probabilistic predictive model for recommending experiment designs for synthetic biology comprising a probabilistic ensemble of the plurality of level-0 learners, wherein an output of the level-1 learner comprises a predicted probabilistic distribution of the at least one response variable.

2.-10. (canceled)

11. The system of claim 1, wherein the synthetic biology experimental data is sparse.

12. The system of claim 1, wherein a number of the plurality of training inputs in the synthetic biology experiment data is a number of experimental conditions, a number of strains, a number of replicates of a strain of the strains, or a combination thereof.

13.-15. (canceled)

16. The system of claim 1, wherein one, or each, of the plurality of input variables and/or the at least one response variable comprises a promoter sequence, an induction time, an induction strength, a ribosome binding sequence, a copy number of a gene, a transcription level of a gene, an epigenetics state of a gene, a level of a protein, a post translation modification state of a protein, a level of a molecule, an identity of a molecule, a level of a microbe, a state of a microbe, a state of a microbiome, a titer, a rate, a yield, or a combination thereof, optionally wherein the molecule comprises an inorganic molecule, an organic molecule, a protein, a polypeptide, a carbohydrate, a sugar, a fatty acid, a lipid, an alcohol, a fuel, a metabolite, a drug, an anticancer drug, a biofuel, a flavoring molecule, a fertilizer molecule, or a combination thereof.

17.-21. (canceled)

22. The system of claim 1, wherein the predetermined response variable objective comprises a maximization objective, a minimization objective, or a specification objective, and/or wherein the predetermined response variable objective comprises maximizing the at least one response variable, minimizing the at least one response variable, or adjusting the at least one response variable to a predetermined value of the at least one response variable.

23. The system of claim 1, wherein to train the plurality of level-1 learner, the hardware processor is programmed by the executable instructions to: determine, using the plurality of level-0 learners, the predicted values of the at least one response variable for training inputs of the plurality of training inputs.

24. The system of claim 1, wherein the level-1 learner comprises a Bayesian ensemble of the plurality of level-0 learners.

25. The system of claim 1, wherein parameters of the ensemble of the plurality of level-0 learners comprises (i) a plurality of ensemble weights and (ii) an error variable distribution of the ensemble or a standard deviation of the error variable distribution of the ensemble.

26.-32. (canceled)

33. The system of claim 1,
wherein to train the level-1 learner, the hardware processor is programmed by the executable instructions to: determine a posterior distribution of the ensemble parameters given the training data or the second subset of the training data,
wherein to determine the posterior distribution of the ensemble parameters given the training data or the second subset of the training data, the hardware processor is programmed by the executable instructions to: determine (i) a probability distribution of the training data or the second subset of the training data given the ensemble parameters or a likelihood function of the ensemble parameters given the training data of the second subset of the training data, and (ii) a prior distribution of the ensemble parameters, and
wherein to determine the posterior distribution of the ensemble parameters given the training data or the second subset of the training data, the hardware processor is programmed by the executable instructions to: sample a space of the ensemble parameters with a frequency proportional to a desired posterior distribution.

34. (canceled)

35. (canceled)

36. The system of claim 1, wherein to train the plurality of level-0 learners, the hardware processor is programmed by the executable instructions to:
generate a first subset of the training data; and
train, using the first subset of the training data, the plurality of level-0 learners.

37.-50. (canceled)

51. The system of claim 1, wherein the hardware processor is programmed by the executable instructions to:
determine a surrogate function with an input experiment design as an input, the surrogate function comprising an expected value of the at least one response variable determined using the input experiment design, a variance of the value of the at least one response variable determined using the input experiment design, and an exploitation-exploration trade-off parameter; and
determine, using the surrogate function, a plurality of recommended experiment designs, each comprising recommended values of the input variables, for a next cycle of a synthetic biology experiment for obtaining a predetermined response variable objective associated with the at least one response variable.

52.-57. (canceled)

58. The system of claim 51, wherein to determine the plurality of recommended experiment designs, the hardware processor is programmed by the executable instructions to:
determine a plurality of possible recommended experiment designs each comprising possible recommended values of the input variables with surrogate function values, determined using the surrogate function, with a predetermined characteristic; and
select the plurality of recommended experiment designs from the plurality of possible recommended experiment designs using an input variable difference factor based on the surrogate function values of the plurality of possible recommended experiment designs.

59.-64. (canceled)

65. The system of claim 51, wherein a number of the plurality of recommended experiment designs is a number of experimental conditions or a number of strains for the next cycle of the synthetic biology experiment.

66. (canceled)

67. (canceled)

68. The system of claim 51, wherein to determine the plurality of possible recommended experiment designs, the hardware processor is programmed by the executable instructions to: sample a space of the input variables with a frequency proportional to the surrogate function, or an exponential function of the surrogate function, and a prior distribution of the input variables.

69. (canceled)

70. The system of claim 51, wherein the hardware processor is programmed by the executable instructions to:
determine an upper bound and/or a lower bound for one, or each, of the plurality of input variables based on training values of the corresponding input variable, wherein each of the possible recommended values of the input variables is within the upper bound and/or the lower bound of the corresponding input variable.

71. (canceled)

72. The system of claim 51, wherein the hardware processor is programmed by the executable instructions to:
receive an upper bound and/or a lower bound for one, or each, of the plurality of input variables, wherein each of the possible recommended values of the input variables is within the upper bound and/or the lower bound of the corresponding input variable.

73. The system of claim 51, wherein the hardware processor is programmed by the executable instructions to:
determine, using the posterior distribution of the ensemble parameters given the training data or the second subset of the training data, a probability distribution of the at least one response variable for one, or each, of the plurality of recommended experiment designs.

74. The system of claim 51, wherein the hardware processor is programmed by the executable instructions to:
determine, using the posterior distribution of the ensemble parameters given the training data or the second subset of the training data, a probability of one, or each, of the plurality of recommended experiment designs achieving the predetermined response variable objective associated with the at least one response variable, optionally wherein the probability of one, or each, of the plurality of recommended experiment designs achieving the predetermined response variable objective associated with the at least one response variable comprises the probability of one, or each, of the plurality of recommended experiment designs being a predetermined percentage closer to achieving the objective relative to the training data.

75. The system of claim 51, wherein the hardware processor is programmed by the executable instructions to:
determine, using the posterior distribution of the ensemble parameters given the training data or the second subset of the training data, a probability of at least one of the plurality of recommended experiment designs achieving the predetermined response variable objective associated with the at least one response variable, optionally wherein the probability of the at least one of the plurality of recommended experiment designs achieving the predetermined response variable objective associated with the at least one response variable comprises the probability of the at least one of the plurality of recommended experiment designs achieving the predetermined response variable objective being a predetermined percentage closer to achieving the objective relative to the training data.

76. (canceled)

77. (canceled)

78. A method for recommending experiment designs for synthetic biology comprising:
under control of a hardware processor:
receiving a probabilistic predictive model for recommending experiment designs for synthetic biology comprising a plurality of level-0 learners and a level-1 learner,
wherein an input of each of the plurality of level-0 learners comprises input values of the input variables, wherein an output of each of the plurality of level-0 learners comprises a predicted value of at least one response variable, wherein the level-1 learner comprises a probabilistic ensemble of the plurality of level-0 learners, wherein an output of the level-1 learner comprises a predicted probabilistic distribution of the at least one response variable,
wherein the plurality of level-0 learners and the level-1 learner are trained using training data obtained from one or more cycles of a synthetic biology experiment comprising a plurality of training inputs and corresponding reference outputs, wherein each of the plurality of training inputs comprises training values of input variables, and wherein each of the plurality of reference outputs comprises a reference value of at least one response variable associated with a predetermined response variable objective;
determining a surrogate function comprising an expected value of the level-1 learner, a variance of the level-1 learner, and an exploitation-exploration trade-off parameter; and
determining, using the surrogate function, a plurality of recommended experiment designs, each comprising recommended values of the input variables, for a next cycle of the synthetic biology experiment for achieving a predetermined response variable objective associated with the at least one response variable.

79.-85. (canceled)
